(19) United States
(12) Patent Application Publication
(10) Pub. No.: US 2015/0010493 A1
(43) Pub. Date: Jan. 8, 2015

(54) SMALL MOLECULE INHIBITORS OF RNA SILENCING

(71) Applicant: The Regents of the University of California, Oakland, CA (US)

(72) Inventor: Shou-Wei DING, Riverside, CA (US)

(21) Appl. No.: 14/318,388

(22) Filed: Jun. 27, 2014

Related U.S. Application Data
(63) Continuation of application No. 12/671,680, filed on Nov. 11, 2011, now abandoned.

(51) Int. Cl. A01N 43/60; A01N 43/08; A01N 25/00; A01N 43/40

(52) U.S. Cl. CPC A01N 43/60; A01N 43/40; A01N 43/08; A01N 25/006
USPC 424/84; 514/319; 514/471; 514/252.12

(57) ABSTRACT

The present invention provides compositions and formulations that contain active compounds as RNAi inhibitors. These compositions and formulations are useful for controlling insects and pests including mosquitoes and agricultural pests.

### RELATED APPLICATION

This application claims priority to U.S. Ser. No. 60/953,389, filed Aug. 1, 2007, the contents of which are herein incorporated by reference in the entirety.

### STATEMENT AS TO RIGHTS TO INVENTIONS MADE UNDER FEDERALLY SPONSORED RESEARCH AND DEVELOPMENT

This work was support in part by a grant from the National Institute of Health under Grant No. AI052447. The government may have rights in certain aspects of the invention.

### BACKGROUND OF THE INVENTION

Insect and pest control is an important component to agricultural production throughout the world and pertains to a wide range of environmental interventions that have their objective to kill or reduce to acceptable level insect pests, plant pathogens and weed populations. Specific control techniques include chemical, physical, and biological control mechanisms. There has been constant search for effective chemical insecticides. However, there are several problems that arise from using chemical insecticides. They include resistance, human toxicity, environment damage, and limited selectivity. Therefore, it is desirable to develop other types of insect and pest controlling means.

RNA interference (RNAi) is a process in which introduction of dsRNA into a cell causes destruction of RNA in a sequence-specific manner (see, D. Baulcombe, Curr. Biol., 12:R83 (2002); Hutvagner et al., Curr. Opin. Genet. Dev., 12:225 (2002)). RNAi has been observed in plants, Neurospora, flies, protozoans, and mice. Available data show that double-stranded (ds) RNA serves as the initial trigger of RNA interference and, upon recognition, is processed by the Dicer RNAse into short fragments of 21 nucleotides (nt) in length. These short interfering (si)RNAs are then incorporated into a dsRNA-induced silencing complex (RISC) to guide cycles of specific RNA degradation.

RNA interference (RNAi) or RNA silencing down regulates gene expression through small interfering RNAs (siRNAs) and microRNAs (miRNAs) in a manner highly conserved in plants, invertebrates, and vertebrates. In Drosophila melanogaster, siRNAs and miRNAs are products of endoribonuclease (RNase) Dicer-2 (Dcr-2) and Dcr-1, respectively, and these small RNAs guide specific gene silencing in Argonaute (Ago) protein-containing effector complexes such as RNA-induced silencing complex (RISC) (Kavi et al., FEBS Lett. 2005, 5940-5949).

Recent work has established that targeted degradation of RNA occurs as a natural antiviral response, rather than simply being a response to artificially introduced or artificially induced dsRNA. The RNAi pathway acts as an innate immunity against virus infection in fruit flies, mosquitoes and nematodes (see, Li, F. et al., Annu Rev Microbiol. 2006; Li, H. W. et al., Science 2002, 296(5571), 1319-1321; Li, W. X. et al., Proc Natl Acad Sci USA 2004, 101(5), 1350-5; Lu, R. et al., Nature 2005, 436(7053), 1040-3; Wang, X. H. et al., Science 2006, 312(5772), 452-4). Successful virus infection of these invertebrate animals requires a virus-encoded protein to suppress RNAi and that adult Drosophila melanogaster carrying a loss-of-function mutation in RNAi pathway genes such as Dcr-2 displays enhanced disease susceptibility to virus infection. Notably, recent studies suggest that miRNAs act as oncogenes in human cancers (Hammond, Cancer Chemother Pharmacol 2006, 58 Suppl 7, 63-8).

Therefore, there is a need to develop compositions and formulations as effective RNAi inhibitors that have i) excellent activity towards target insects and low toxicity towards non-target species, ii) better selectivity, iii) lower undesirable environmental impact, iv) lack of phytotoxicity, and v) higher effectiveness against insects resistant to many known insecticides. In particular, the compositions and formulations allow the controlling of the insects, such as mosquitoes and agricultural pests as well as treating human diseases. The present invention fulfills these and other related needs.

### BRIEF SUMMARY OF THE INVENTION

In one aspect, the present invention provides a pharmaceutical composition for controlling insects. The composition includes a compound of formula I:

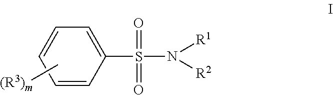

and a pharmaceutically acceptable carrier or excipient, wherein R¹ is selected from the group consisting of —H and alkyl; R² is heterocycloalkyl-C₁₋₄alkylene; or R¹ and R² together with the nitrogen atom to which they are attached to form a 5- or 6-membered hetercyclic ring containing 1-3 heteroatoms selected from 0 or N, wherein the heterocycloalkyl is optionally substituted with from 1-2 members selected from the group consisting of alkyl and aryl-C₁₋₄alkyl, wherein the aryl group is substituted with from 1-2 members selected from the group consisting of alkyl, alkoxy and arylalkyloxy; each R³ is independently selected from the group consisting of alkyl, alkoxy, —C(O)OH and —C(O)Oalkyl, or any two R³ together with the atoms to which they are attached are combined to form a 6-membered carbocyclic aromatic ring, optionally substituted with alkoxy; and m is an integer from 1-5.

In a second aspect, the present invention provides a pharmaceutical composition for controlling insects. The composition includes a compound of formula II:

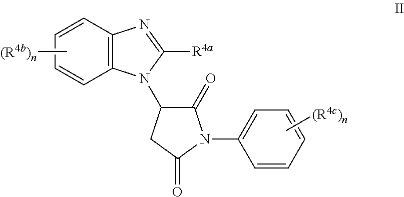

and a pharmaceutically acceptable carrier or excipient, wherein R^{4a}, R^{4b} and R^{4c} are each independently a H or C₁₋₈alkyl; and each n is independently an integer from 1-4.

In a third aspect, the present invention provides a pharmaceutical composition for controlling insects. The composition includes a compound of formula III:

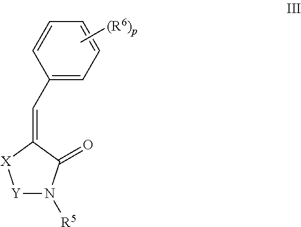

and a pharmaceutically acceptable carrier or excipient, wherein X is —S—, —C(═S)— or —C(═O)—; Y is —NH—, —NC₁₋₈alkyl-, —C(═O)— or —C(═S)—; R⁵ is H, C₁₋₈alkyl or aryl; R⁶ is selected from the group consisting of —OH, C₁₋₈alkyoxy, —NH₂, —NHC₁₋₈alkyl, —N(C₁₋₈alkyl)₂ and aryl-C₀₋₄alkyloxy; and p is an integer from 1-5.

In a fourth aspect, the present invention provides a pharmaceutical composition for controlling insects. The composition includes a compound of formula IV:

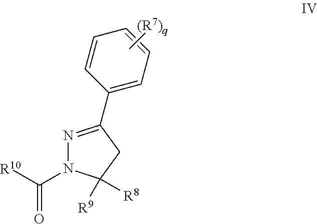

and a pharmaceutically acceptable carrier or excipient, wherein R⁷ is —H or halo; R⁸ is —H or haloalkyl; R⁹ is aryl, —OH or alkoxy; R¹⁰ is aryl or heteroalkyl; and q is an integer from 1-5.

In a fifth aspect, the present invention provides a pharmaceutical composition for controlling insects. The composition includes a compound of formula V:

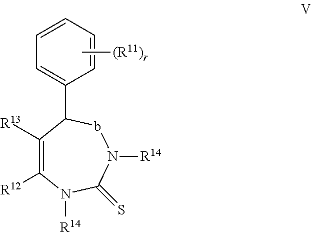

and a pharmaceutically acceptable carrier or excipient, wherein R¹¹ is —H or alkoxy; R¹² is alkyl; R¹³ is —H or aryl-NR^{a}C(O)—, wherein R^{a} is —H, alkyl or aryl; each R¹⁴ is independently a lone pair, H or alkyl; the subscript r is an integer from 1-5; and the subscript b is a single bond or a double bond.

In sixth aspect, the present invention provides a pharmaceutical composition for controlling insects. The composition includes a compound of formula VI:

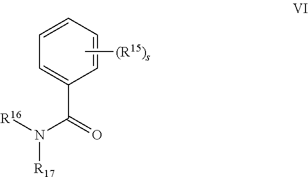

and a pharmaceutically acceptable carrier or excipient, wherein R¹⁵ is selected from the group consisting of alkoxy and halo; the subscript s is an integer from 1-2; R¹⁶ is —H or alkyl; and R¹⁷ is selected from the group consisting of aryl, heteroaryl-C(O)-alkyl and arylalkyl.

In a seventh aspect, the present invention provides a pharmaceutical composition for controlling insects. The composition includes a compound of formula VII:

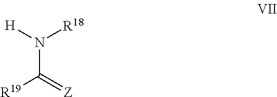

and a pharmaceutically acceptable carrier or excipient, wherein R¹⁸ is aryl or alkyl; Z is ═O or ═S; R¹⁹ is aryl-C₁₋₄alkyl or cycloalkyl-(R^{b})N—, wherein R^{b} is —H or alkyl.

In an eighth aspect, the present invention provides a pharmaceutical composition for controlling insects. The composition includes a compound selected from the group consisting of:

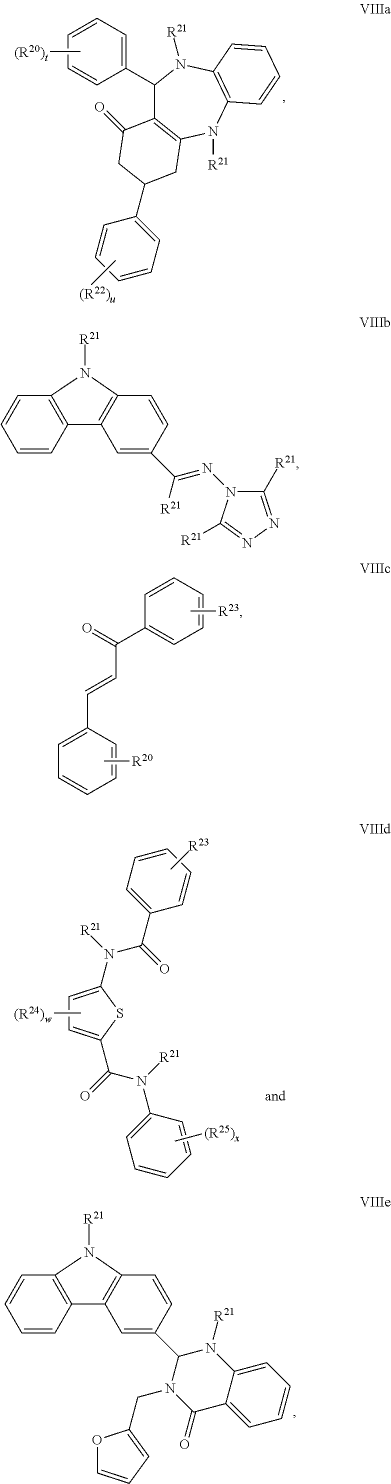

wherein each R²⁰ is independently —OH or an alkoxy; each R²¹ is independently —H or an alkyl; each R²² is independently an alkoxy or any two R²² substituents together with the atoms to which they are attached combined to form a 5-membered ring having from 1-2 heteroatoms selected from N or O; R²³ is —H or a halo; each R²⁴ is independently an alkyl or alkyl-OC(O)—; each R²⁵ is independently a halo or haloalkyl; the subscript t is an integer from 1-3; the subscript u is an integer from 1-2; the subscript w is an integer from 1-2; and the subscript x is an integer from 1-3.

In another aspect, the present invention provides a method of inhibiting RNA silencing mediated viral immunity in an insect. The method includes contacting a pharmaceutical composition with a cell.

In yet another aspect, the present invention provides a formulation for use in controlling insects. The formulation includes a composition that contains at least one RNAi inhibitor and an additive and is in the form of a spray, liquid, cream, gel, ointment, or towelette. Preferably, the formulation is environmentally compatible and exhibiting little or no phytotoxicity.

In still another aspect, the present invention provides a compound as described herein (i.e., a compound of any of formulas I-VII and VIIIa-VIIIe) for use in controlling insects or agriculture pests. In one embodiment, the invention provides a compound as described herein (i.e. a compound of any of formulas I-VII and VIIIa-VIIIe) for use in inhibiting RNA silencing mediated viral immunity in insects.

### BRIEF DESCRIPTION OF THE DRAWINGS

FIG. 1 illustrates the accumulation of FHV RNA1 and RNA3 in Drosophila cell line R1gfp treated with DMSO (1%) alone (lane 1) or plus 30 μM Rin1 (lane 4), Rin2 (lane 2) and Rin3 (lane 3).

FIG. 2 illustrates the northern blot detection of Cyclin A mRNA in S2 cells. Total RNAs were extracted from untreated S2 cells (lanes 6-7), cells treated with dsGFP (lane 8) or cells treated with dsCycA alone (lanes 1-2), dsCycA plus 30 μM of Rin1 (lane 3), Rin2 (lane 4), Rin3 (lane 5), or dsCycA plus dsAgo2 (lane 9), which depleted, AGO2 thereby inhibiting RNAi.

FIG. 3 illustrates the northern blot detection of Cyclin A mRNA in S2 cells. Total RNAs were extracted from cells treated with cyclin A siRNAs and 30 μM of chemicals (lanes 1-3), 100 μM (lanes 4-6) or untreated (lane 7). RNA was also extracted from cells transfected with no siRNA and treated with 30 μM of chemicals (lanes 8-11).

FIG. 4 illustrates Northern blot detection of miR2b in Drosophila S2 cells. Total RNAs from S2 cells either untreated (WT) or treated with Rin (lanes 2-4) were probed for the accumulation of both the mature and precursor miR2b.

### DETAILED DESCRIPTION OF THE INVENTION

### I. Definitions

As used herein, the following terms have the meanings ascribed to them unless specified otherwise.

The term “alkyl”, by itself or as part of another substituent, means, unless otherwise stated, a straight or branched chain hydrocarbon radical, having the number of carbon atoms designated (i.e. C₁₋₈ means one to eight carbons). Examples of alkyl groups include methyl, ethyl, n-propyl, isopropyl, n-butyl, t-butyl, isobutyl, sec-butyl, n-pentyl, n-hexyl, n-heptyl, n-octyl, and the like. The term “alkenyl” refers to an unsaturated alkyl group having one or more double bonds. Examples of such unsaturated alkyl groups include vinyl, 2-propenyl, crotyl, 2-isopentenyl, 2-(butadienyl), 2,4-pentadienyl, 3-(1,4-pentadienyl), and the higher homologs and isomers. The term “cycloalkyl” refers to hydrocarbon rings having the indicated number of ring atoms (e.g., C₃₋₆cycloalkyl) and being fully saturated or having no more than one double bond between ring vertices. One or two C atoms may optionally be replaced by a carbonyl. “Cycloalkyl” is also meant to refer to bicyclic and polycyclic hydrocarbon rings such as, for example, bicyclo[2.2.1]heptane, bicyclo[2.2.2]octane, etc. The term “heterocycloalkyl” refers to a cycloalkyl group that contain from one to five heteroatoms selected from N, O, and S, wherein the nitrogen and sulfur atoms are optionally oxidized, and the nitrogen atom(s) are optionally quaternized, the remaining ring atoms being C, where one or two C atoms may optionally be replaced by a carbonyl. The heterocycloalkyl may be a monocyclic, a bicyclic or a polycylic ring system. The heterocycloalkyl can also be a heterocyclic alkyl ring fused with an aryl or a heteroaryl ring. Non limiting examples of heterocycloalkyl groups include pyrrolidine, piperidiny, imidazolidine, pyrazolidine, butyrolactam, valerolactam, imidazolidinone, hydantoin, dioxolane, phthalimide, piperidine, 1,4-dioxane, morpholine, thiomorpholine, thiomorpholine-S-oxide, thiomorpholine-S,S-oxide, piperazine, pyran, pyridone, 3-pyrroline, thiopyran, pyrone, tetrahydrofuran, tetrhydrothiophene, quinuclidine, and the like. A heterocycloalkyl group can be attached to the remainder of the molecule through a ring carbon or a heteroatom.

The term “heterocyclic” refers to a saturated or unsaturated non-aromatic cyclic radical of 3 to 8 ring atoms in which one or two ring atoms are heteroatoms selected from O, NR (where R is independently hydrogen or alkyl) or S(O)ₙ (where n is an integer from 0 to 2), the remaining ring atoms being C, where one or two C atoms may optionally be replaced by a carbonyl group. The heterocyclic ring may be optionally substituted independently with one, two, or three substituents selected from alkyl, halo, cyano, hydroxy, alkoxy, amino, mono-alkylamino, di-alkylamino, haloalkyl, haloalkoxy, —COR (where R is hydrogen, alkyl, cycloalkyl, cycloalkyl-alkyl, phenyl or phenylalkyl), —(CR′R″)ₙ—COOR (n is an integer from 0 to 5, R′ and R″ are independently hydrogen or alkyl, and R is hydrogen, alkyl, cycloalkyl, cycloalkyl-alkyl, phenyl or phenylalkyl), or —(CR′R″)ₙ—CONR^{a}R^{b} (where n is an integer from 0 to 5, R′ and R″ are independently hydrogen or alkyl, and R^{a} and R^{b} are, independently of each other, hydrogen, alkyl, phenyl or phenylalkyl). More specifically the term heterocyclic includes, but is not limited to, tetrahydropyranyl, piperidino, N-methylpiperidin-3-yl, piperazino, N-methylpyrrolidin-3-yl, 3-pyrrolidino, 2-pyrrolidon-1-yl, morpholino, thiomorpholino, thiomorpholino-1-oxide, thiomorpholino-1,1-dioxide, pyrrolidinyl, and the derivatives thereof. The prefix indicating the number of carbon atoms (e.g., C₃-C₁₀) refers to the total number of carbon atoms in the portion of the heterocyclic group exclusive of the number of heteroatoms.

The term “alkylene” by itself or as part of another substituent means a divalent radical derived from an alkane, as exemplified by —CH₂CH₂CH₂CH₂—. Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having four or fewer carbon atoms.

The term “heteroalkyl,” by itself or in combination with another term, means, unless otherwise stated, a stable straight or branched chain, or cyclic hydrocarbon radical, or combinations thereof, consisting of the stated number of carbon atoms and from one to three heteroatoms selected from the group consisting of O, N, Si and S, and wherein the nitrogen and sulfur atoms may optionally be oxidized and the nitrogen heteroatom may optionally be quaternized. The heteroatom(s) O, N and S may be placed at any interior position of the heteroalkyl group. The heteroatom Si may be placed at any position of the heteroalkyl group, including the position at which the alkyl group is attached to the remainder of the molecule. Examples include —CH₂—CH₂—O—CH₃, —CH₂—CH₂—NH—CH₃, —CH₂—CH₂—N(CH₃)—CH₃, —CH₂—S—CH₂—CH₃, —CH₂—CH₂—S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. In some embodiments, The term “heteroalkyl” refers to an alkyl radical as defined herein with one, two or three substituents independently selected from cyano, —OR^{a}, —NR^{b}R^{c} and —S(O)ₙR^{d} (where n is an integer from 0 to 2), with the understanding that the point of attachment of the heteroalkyl radical is through a carbon atom of the heteroalkyl radical. R^{a} is hydrogen, alkyl, aryl, arylalkyl, alkoxycarbonyl, aryloxycarbonyl, carboxamido, or mono- or di-alkylcarbamoyl. R^{b} is hydrogen, alkyl, aryl or arylalkyl. R^{c} is hydrogen, alkyl, aryl, arylalkyl, alkoxycarbonyl, aryloxycarbonyl, carboxamido, mono- or di-alkylcarbamoyl or alkylsulfonyl. R^{d} is hydrogen (provided that n is 0), alkyl, aryl, arylalkyl, amino, mono-alkylamino, di-alkylamino, or hydroxyalkyl. Representative examples include, for example, 2-hydroxyethyl, 2,3-dihydroxypropyl, 2-methoxyethyl, benzyloxymethyl, 2-cyanoethyl, and 2-methyl sulfonyl-ethyl. For each of the above, R^{a}, R^{b}, R^{c}, and R^{d} can be further substituted by NH₂, fluorine, alkylamino, di-alkylamino, OH or alkoxy. Additionally, the prefix indicating the number of carbon atoms (e.g., C₁-C₁₀) refers to the total number of carbon atoms in the portion of the heteroalkyl group exclusive of the cyano, —OR^{a},—NR^{b}R^{c}, or —S(O)ₙR^{d} portions.

The terms “alkoxy,” “alkylamino” and “alkylthio” (or thioalkoxy) are used in their conventional sense, and refer to those alkyl groups attached to the remainder of the molecule via an oxygen atom, an amino group, or a sulfur atom, respectively. Additionally, for dialkylamino groups, the alkyl portions can be the same or different and can also be combined to form a 3-7 membered ring with the nitrogen atom to which each is attached. Accordingly, a group represented as —NR^{a}R^{b} is meant to include piperidinyl, pyrrolidinyl, morpholinyl, azetidinyl and the like.

The terms “halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “C₁₋₄ haloalkyl” is mean to include trifluoromethyl, 2,2,2-trifluoroethyl, 4-chlorobutyl, 3-bromopropyl, and the like.

The term “aryl” means, unless otherwise stated, a polyunsaturated, typically aromatic, hydrocarbon group which can be a single ring or multiple rings (up to three rings) which are fused together or linked covalently. The term “heteroaryl” refers to aryl groups (or rings) that contain from one to five heteroatoms selected from N, O, and S, wherein the nitrogen and sulfur atoms are optionally oxidized, and the nitrogen atom(s) are optionally quaternized. A heteroaryl group can be attached to the remainder of the molecule through a heteroatom. Non-limiting examples of aryl groups include phenyl, naphthyl and biphenyl, while non-limiting examples of heteroaryl groups include pyridyl, pyridazinyl, pyrazinyl, pyrimindinyl, triazinyl, quinolinyl, quinoxalinyl, quinazolinyl, cinnolinyl, phthalaziniyl, benzotriazinyl, purinyl, benzimidazolyl, benzopyrazolyl, benzotriazolyl, benzisoxazolyl, isobenzofuryl, isoindolyl, indolizinyl, benzotriazinyl, thienopyridinyl, thienopyrimidinyl, pyrazolopyrimidinyl, imidazopyridines, benzothiaxolyl, benzofuranyl, benzothienyl, indolyl, quinolyl, isoquinolyl, isothiazolyl, pyrazolyl, indazolyl, pteridinyl, imidazolyl, triazolyl, tetrazolyl, oxazolyl, isoxazolyl, thiadiazolyl, pyrrolyl, thiazolyl, furyl, thienyl and the like. Substituents for each of the above noted aryl and heteroaryl ring systems are selected from the group of acceptable substituents described below.

For brevity, the term “aryl” when used in combination with other terms (e.g., aryloxy, arylthioxy, arylalkyl) includes both aryl and heteroaryl rings as defined above. Thus, the term “arylalkyl” is meant to include those radicals in which an aryl group is attached to an alkyl group (e.g., benzyl, phenethyl, pyridylmethyl and the like).

The above terms (e.g., “alkyl”, “aryl” and “heteroaryl”), in some embodiments, will include both substituted and unsubstituted forms of the indicated radical. Preferred substituents for each type of radical are provided below. For brevity, the terms aryl and heteroaryl will refer to substituted or unsubstituted versions as provided below, while the term “alkyl” and related aliphatic radicals is meant to refer to unsubstituted version, unless indicated to be substituted.

Substituents for the alkyl radicals (including those groups often referred to as alkylene, alkenyl, alkynyl and cycloalkyl) can be a variety of groups selected from: -halogen, —OR′, —NR′R″, —SR′, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NH—C(NH₂)═NH, —NR′C(NH₂)═NH, —NH—C(NH₂)═NR′, —S(O)R′, —S(O)₂R′, —S(O)₂NR′R″, —NR′S(O)₂R″, —CN and —NO₂ in a number ranging from zero to (2 m′+1), where m′ is the total number of carbon atoms in such radical. R′, R″ and R′″ each independently refer to hydrogen, unsubstituted C₁₋₈ alkyl, unsubstituted heteroalkyl, unsubstituted aryl, aryl substituted with 1-3 halogens, unsubstituted C₁₋₈ alkyl, C₁₋₈ alkoxy or C₁₋₈ thioalkoxy groups, or unsubstituted aryl-C₁₋₄ alkyl groups. When R′ and R″ are attached to the same nitrogen atom, they can be combined with the nitrogen atom to form a 3-, 4-, 5-, 6-, or 7-membered ring. For example, —NR′R″ is meant to include 1-pyrrolidinyl and 4-morpholinyl. The term “acyl” as used by itself or as part of another group refers to an alkyl radical wherein two substitutents on the carbon that is closest to the point of attachment for the radical is replaced with the substitutent ═O (e.g., —C(O)CH₃, —C(O)CH₂CH₂OR′ and the like). One of skill in the art will understand that the term “alkyl” in its broadest sense is meant to include groups such as haloalkyl (e.g., —CF₃, —CH₂CF₃) and acyl (e.g. —C9O)CH₃, —C(O)CF₃, —C(O)CH₂OCH₃, and the like). Preferably, the alkyl groups will have from 0-3 substituents, more preferably 0, 1, 2 substituents, unless otherwise specified).

Substituents for the aryl and heteroaryl groups are varied and are generally selected from: -halogen, —OR′, —OC(O)R′, —NR′R″, —SR′, —R′, —CN, —NO₂, —CO₂R′, —CONR′R″, —C(O)R′, —OC(O)NR′R″, —NR″C(O)R′, —NR″C(O)₂R′, —NR′—C(O)NR″R′″, —NH—C(NH₂)═NH, —NR′C(NH₂)═NH, —NH—C(NH₂)═NR′, —S(O)R′, —S(O)₂R′, —S(O)₂NR′R″, —NR′S(O)₂R″, —N₃, perfluoro(C₁-C₄)alkoxy, and perfluoro(C₁-C₄)alkyl, in a number ranging from zero to the total number of open valences on the aromatic ring system; and where R′, R″ and R′″ are independently selected from hydrogen, C₁₋₈ alkyl, C₃₋₆ cycloalkyl, C₂₋₈ alkenyl, C₂₋₈ alkynyl, unsubstituted aryl and heteroaryl, (unsubstituted aryl)-C₁₋₄ alkyl, and unsubstituted aryloxy-C₁₋₄ alkyl. Other suitable substituents include each of the above aryl substituents attached to a ring atom by an alkylene tether of from 1-4 carbon atoms.

Two of the substituents on adjacent atoms of the aryl or heteroaryl ring may optionally be replaced with a substituent of the formula -T-C(O)—(CH₂)_{q}—U—, wherein T and U are independently —NH—, —O—, —CH₂— or a single bond, and q is an integer of from 0 to 2. Alternatively, two of the substituents on adjacent atoms of the aryl or heteroaryl ring may optionally be replaced with a substituent of the formula -A-(CH₂)ᵣ—B—, wherein A and B are independently —CH₂—, —O—, —NH—, —S—, —S(O)—, —S(O)₂—, —S(O)₂NR′— or a single bond, and r is an integer of from 1 to 3. One of the single bonds of the new ring so formed may optionally be replaced with a double bond. Alternatively, two of the substituents on adjacent atoms of the aryl or heteroaryl ring may optionally be replaced with a substituent of the formula —(CH₂)ₛ—X—(CH₂)ᵣ, where s and t are independently integers of from 0 to 3, and X is —O—, —NR′—, —S—, —S(O)—, —S(O)₂—, or —S(O)₂NR′—. The substituent R′ in —NR′— and —S(O)₂NR′— is selected from hydrogen or unsubstituted C₁₋₆ alkyl.

As used herein, the term “heteroatom” is meant to include oxygen (O), nitrogen (N), sulfur (S) and silicon (Si).

The term “composition” as used herein is intended to encompass a product comprising the specified ingredients in the specified amounts, as well as any product which results, directly or indirectly, from combination of the specified ingredients in the specified amounts. By “pharmaceutically acceptable,” it is meant the carrier, diluent or excipient must be compatible with the other ingredients of the formulation and deleterious to the recipient thereof.

As used herein, the term “effective amount” in reference to the amount of a compound in a pharmaceutical composition means the amount of compound or composition that is sufficient to achieve the intended results, for example, to control the proliferation of certain insects or to kill the insects, when the composition is applied following a predetermined regiment.

The term “RNA silencing” as used herein refers to the degradation of RNA as a process induced by a natural “trigger,” e.g., viral infection, rather than artificial manipulation, which is referred to as RNA interference, or RNAi. In this application, the term specifically refers to the antiviral defense mechanism by which viral RNA is degraded in response to viral infection in a cell, e.g., an insect cell.

The term “RNAi” or “RNA interference” as used herein refers to the degradation of RNA induced by introduction of dsRNA into a cell or manipulations designed to induce cells to produce artificial dsRNA.

The term “bait” or “attractant” as used herein refers to any substance used to attract insects or pests.

The term “surfactant” refers to any agent that alters the surface properties of the oil and water components in the composition to aid in the formation of an emulsion. Surfactants useful in the present invention include, but are not limited to, a non-ionic surfactant, a cationic surfactant, an anionic surfactant, an amphoteric surfactant, an ampholytic surfactant, a fatty alcohol, a fatty acid and fatty acid salts thereof.

### II. General

The present invention provides compositions, formulations and methods, which are useful for controlling insects by inhibiting the viral immunity of the insects mediated by the RNA silencing (RNAs) pathway. The compositions and formulations of this invention contain active compounds that can suppress RNAs and RNAi in the cells of various organisms, such as insect cells. In some embodiments, the compositions further contain additives including, but not limiting to, stimulants, baits, filler, water and surfactants. The methods include applying the compositions and formulations to the insects, particularly agricultural pests.

Advantageously, the present invention provides a general and universal approach for controlling undesirable insect species, which is also non-toxic and environmentally benign. In particular, the compositions have i) excellent anti-insect activity against a broad spectrum of pest species, ii) lower undesirable environmental impact, iv) lack of phytotoxicity, and v) minimal resistance from the insects, thus higher effectiveness against insects resistant to many known insecticides.

### III. Compositions

### Compounds

In one aspect, the present invention provides a pharmaceutical composition for controlling insects. The composition includes a compound of formula I:

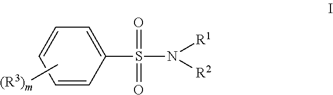

and a pharmaceutically acceptable carrier or excipient. m is an integer from 1-5. In one embodiment, m is 1. In another embodiment, m is 2.

In formula I, R² is selected from the group consisting of —H and alkyl. In one embodiment, R¹ is —H or C₁₋₈alkyl.

In formula I, R² is heterocycloalkyl-C₁₋₄alkylene; or R¹ and R² together with the nitrogen atom to which they are attached to form a 5- or 6-membered hetercyclic ring containing 1-3 heteroatoms selected from 0 or N, wherein the heterocycloalkyl is optionally substituted with from 1-2 members selected from the group consisting of alkyl and aryl-C₁₋₄alkyl, wherein the aryl group is substituted with from 1-2 members selected from the group consisting of alkyl, alkoxy and arylalkyloxy. In one embodiment, R² is C₄-heterocycloalkyl-C₁₋₄alkylene. In another embodiment, R² is furyl-2-methyl.

In one group of embodiments of compounds having formula I, substituents —NR¹R² is selected from the group consisting of piperidinyl and piperazinyl, each of which is optionally substituted with alkyl or aryl. In one instance, —NR¹R² is 1-piperidinyl substituted with an alkyl, such as C₁₋₈alkyl. In another instance, —NR¹R² is 1-piperazinyl substituted with an arylalkyl, wherein the aryl group is further substituted with 1-2 members selected from C₁₋₈ alkoxy and aryl-C₁₋₄alkyloxy. In one occurrence, the arylalkyl is benzyl substituted with 1-2 members selected from C₁₋₈alkoxy and phenyl-C₁₋₄alkyloxy.

In formula I, each R³ is independently selected from the group consisting of alkyl, alkoxy, —C(O)OH and —C(O)Oalkyl, or any two R³ together with the atoms to which they are attached are combined to form a 6-membered carbocyclic aromatic ring, optionally substituted with alkoxy. In one embodiment, R³ is selected from the group consisting of C₁₋₈alkyl, C₁₋₈alkoxy, —C(O)OH and —C(O)OC₁₋₈alkyl. In another embodiment, R³ is selected from the group consisting of C₁₋₈alkoxy, —C(O)OH and —C(O)OC₁₋₈alkyl.

In one embodiment, the compound has a formula selected from the group consisting of:

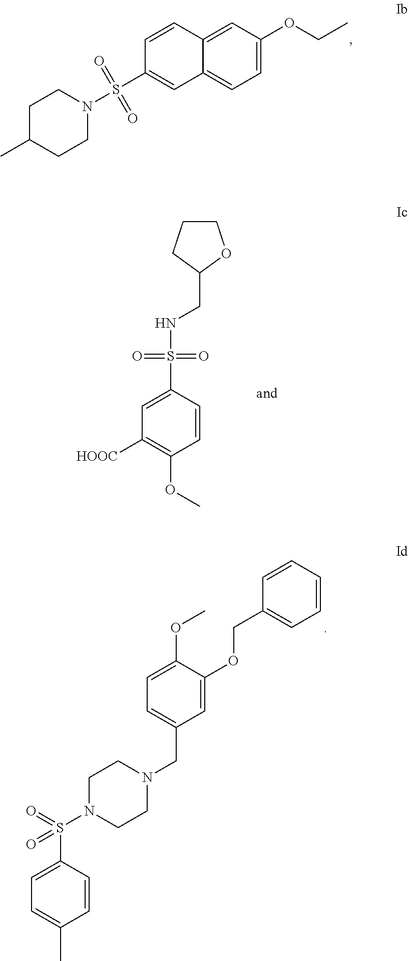 [SMILES: CCOc1ccc2cc(S(=O)(=O)N3CCC(C)CC3)ccc2c1 ; COc1ccc(S(=O)(=O)NCC2CCCO2)cc1C(=O)O ; COc1ccc(CN2CCN(S(=O)(=O)c3ccc(C)cc3)CC2)cc1OCc1ccccc1]

In another embodiment, the compounds of formula I have a subformula Ia:

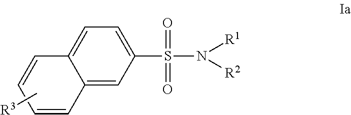

In a second aspect, the present invention provides a pharmaceutical composition for controlling insects. The composition includes: a compound of formula II:

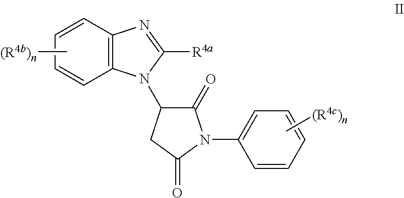

and a pharmaceutically acceptable carrier or excipient. n is independently an integer from 1-4. In one embodiment, n is 1.

In formula II, R^{4a}, R^{4b} and R^{4c} are each independently a H or C₁₋₈alkyl. In one embodiment, R^{4a} is methyl. In another embodiment, R^{4b} is —H. In yet another embodiment, R^{4c} is methyl. In one instance, R^{4c} is methyl at the meta position to the nitrogen substituent.

In one embodiment, the compounds of formula II have a subformula IIa:

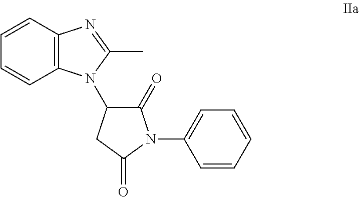 [SMILES: Cc1nc2ccccc2n1C1CC(=O)N(c2ccccc2)C1=O]

In a third aspect, the present invention provides a pharmaceutical composition for controlling insects. The composition includes: a compound of formula III:

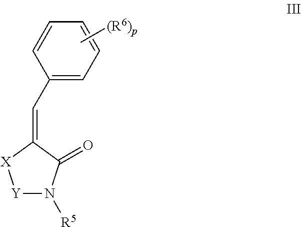

and a pharmaceutically acceptable carrier or excipient. p is an integer from 1-5. In one embodiment, p is 1. In another embodiment, p is 2.

In formula III, X is —S—, —C(═S)— or —C(═O)—. In one embodiment, X is —S—. In another embodiment, X is —C(═O)—.

In formula III, Y is —NH—, —NC₁₋₈alkyl-, —C(═O)— or —C(═S)—. In one embodiment, Y is —(C═S)—. In another embodiment, Y is —NH—.

In formula III, R⁵ is H, C₁₋₈alkyl or aryl. In one embodiment, R⁵ is —H. In another embodiment, R⁵ is aryl. In one instance, R⁵ is phenyl optionally substituted with from 1-2 members selected from the group consisting of alkyl and halo. For example, the substituents are C₁₋₈alkyl and —Cl. In one occurrence, R⁵ is 3-chloro-4-methylphenyl.

In formula III, R⁶ is selected from the group consisting of —OH, C₁₋₈alkyoxy, —NH₂, —NHC₁₋₈alkyl, —N(C₁₋₈alkyl)₂ and aryl-C₀₋₄alkyloxy. In one embodiment, R⁶ is aryl-C₀₋₄alkyloxy, wherein the aryl group is substituted with from 1-3 members selected from —COOH or —COOC₁₋₈alkyl. In certain instances, R⁶ is aryl-C₁₋₄alkyoxy, wherein the aryl group is substituted with —COOH. For example, R⁶ is phenylmethyoxy, wherein the phenyl group is substituted with —COOH at the 3-position. In another embodiment, each R⁶ is independently selected from the group consisting of —OH, C₁₋₈alkyoxy, —NH₂, —NHC₁₋₈alkyl and —N(C₁₋₈alkyl)₂. In certain instances, R⁶ is independently selected from the group consisting of —OH, alkoxy and diethylamino.

In one embodiment, the compound of formula III has a formula selected from the group consisting of:

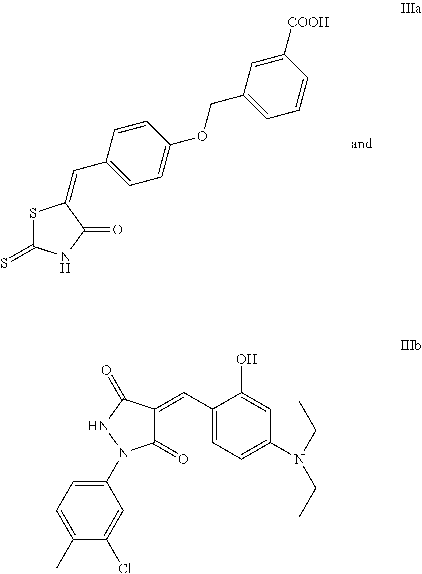 [SMILES: O=C1NC(=S)S/C1=C/c1ccc(OCc2cccc(C(=O)O)c2)cc1 ; CCN(CC)c1ccc(/C=C2/C(=O)NN(c3ccc(C)c(Cl)c3)C2=O)c(O)c1]

In a fourth aspect, the present invention provides a pharmaceutical composition for controlling insects. The composition includes: a compound of formula IV:

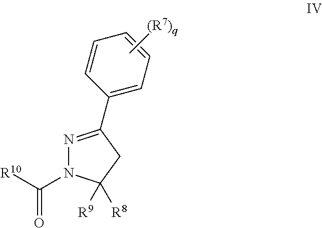

and a pharmaceutically acceptable carrier or excipient. q is an integer from 1-5. In one embodiment, q is 1. In another embodiment, q is 2.

In formula IV, R⁷ is halo. In one embodiment, R⁷ is Cl or Br.

In formula IV, R⁸ is —H or haloalkyl. In one embodiment, R⁸ is C₁₋₈haloalkyl. In one instance, R⁸ is —CF₃.

In formula IV, R⁹ is aryl, —OH or alkoxy. In one embodiment, R⁹ is aryl or —OH. In certain instances, R⁹ is 3,4-dimethoxyphenyl or —OH.

In formula IV, R¹⁰ is aryl or heteroalkyl. In one embodiment, R¹⁰ is HOC(O)—C₁₋₄alkylene. For example, R¹⁰ is HOC(O)—CH₂CH₂—. In another embodiment, R¹⁰ is substituted phenyl. For example, R¹⁶ is 2-hydroxy-3-methylphenyl.

In formula IV, the compound has a formula selected from the group consisting of:

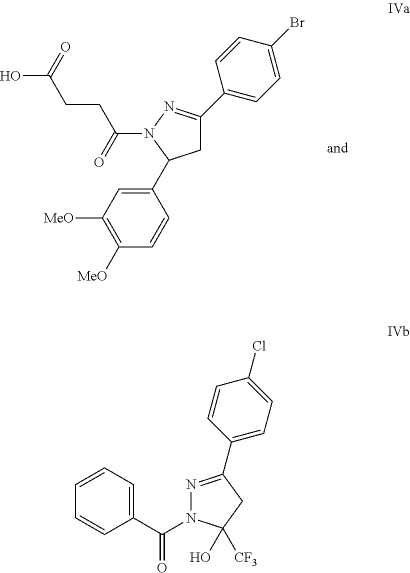 [SMILES: COc1ccc(C2CC(c3ccc(Br)cc3)=NN2C(=O)CCC(=O)O)cc1OC ; O=C(c1ccccc1)N1N=C(c2ccc(Cl)cc2)CC1(O)C(F)(F)F]

In a fifth aspect, the present invention provides a pharmaceutical composition for controlling insects. The composition includes: a compound of formula V:

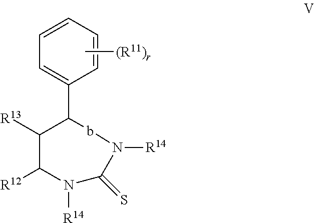

and a pharmaceutically acceptable carrier or excipient. The subscript r is an integer from 1-5. In one embodiment, r is 2.

In formula V, R¹¹ is —H or alkoxy. In one embodiment, R¹¹ is C₁₋₈alkoxy. In certain instances, each R¹¹ is independently —H or methoxy. In certain other instances, when r=2, R¹¹ is methoxy at ortho and meta positions.

In formula V, R¹² is alkyl. In one embodiment, R¹² is C₁₋₈alkyl.

In formula V, R¹³ is —H or aryl-NR^{a}C(O)—, wherein R^{a} is —H, alkyl or aryl. In one embodiment, R¹³ is —H or aryl-NHC(O)—. In one instance, R¹³ is 4-bromophenyl-NHC(O)—.

In formula V, each R¹⁴ is independently a lone pair, H or alkyl. In one embodiment, R¹⁴ is —H or C₁₋₈alkyl.

Symbol b is a single bond or a double bound. When b is a double bond, R¹⁴ is a lone pair.

In one embodiment, the compound of formula V has a formula selected from the group consisting of:

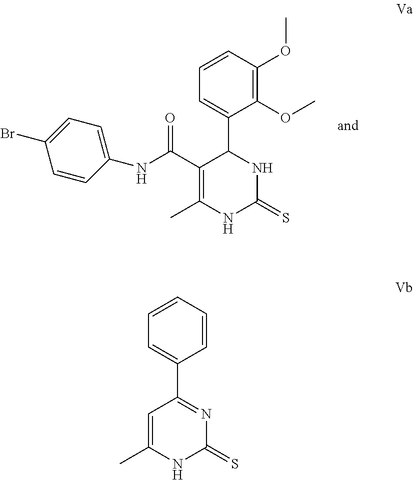

In a sixth aspect, the present invention provides a pharmaceutical composition for controlling insects. The composition includes a compound of formula VI:

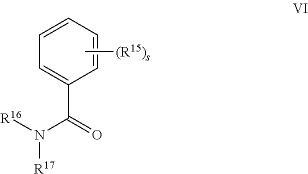

and a pharmaceutically acceptable carrier or excipient. Symbol s is 1 or 2.

In formula VI, IC is independently selected from the group consisting of alkoxy and halo. In one embodiment, each R¹⁵ is independently C₁₋₈alkoxy or halo. In certain instances, R¹⁵ is each independently methoxy, ethyoxy, Cl or —F.

In formula VI, R¹⁶ is —H or alkyl. In one embodiment, R⁶ is —H or C₁₋₈alkyl.

In formula VI, R¹⁷ is selected from the group consisting of aryl, heteroaryl-C(O)-alkyl and arylalkyl. In one embodiment, R¹⁷ is substituted phenyl, heteroaryl-C(O)CH₂— and arylalkyl. In certain instances, R¹⁷ is 3-chloro-6-hydroxycarbonylphenyl, dimethylpyrazoly-C(O)—CH₂— or benzyl.

In one embodiment, the compound of formula VI has a formula selected from the group consisting of:

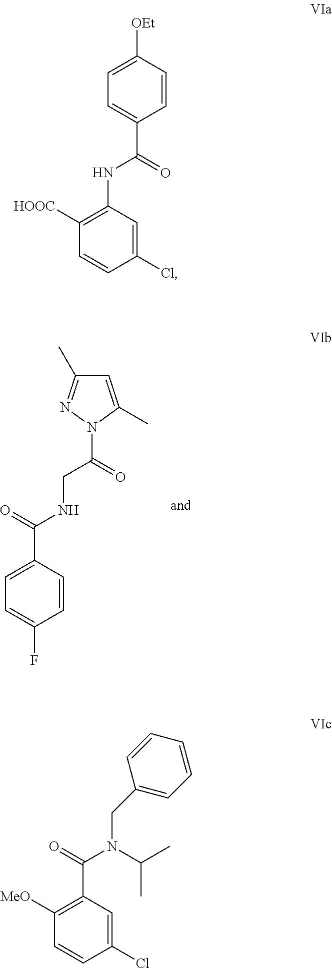 [SMILES: CCOc1ccc(C(=O)Nc2cc(Cl)ccc2C(=O)O)cc1 ; Cc1cc(C)n(C(=O)CNC(=O)c2ccc(F)cc2)n1 ; COc1ccc(Cl)cc1C(=O)N(Cc1ccccc1)C(C)C]

In a seventh aspect, the present invention provides a pharmaceutical composition for controlling insects. The composition includes a compound of formula VII:

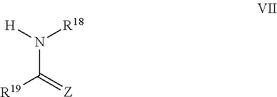

and a pharmaceutically acceptable carrier or excipient. Z is ═O or ═S.

In formula VII, R¹⁸ is aryl or alkyl. In one embodiment, R¹⁸ is aryl or C₁₋₈alkyl. In certain instances, R¹⁸ is 3-hydroxyphenyl.

In formula VII, R¹⁹ is aryl-C₁₋₄alkyl or cycloalkyl-(R^{b})N—, wherein R^{b} is —H or alkyl. In one embodiment, R¹⁹ is aryl-C₁₋₄alkyl. In another embodiment, R¹⁹ is 4-C₁₋₈alkylphenyl-C₁₋₄alkyl. In certain instances, R¹⁹ is 4-isobutylphenyl-C₂alkylene. In certain other instances, R¹⁹ is admantyl.

In one embodiment, compound of formula VII has a formula selected from the group consisting of:

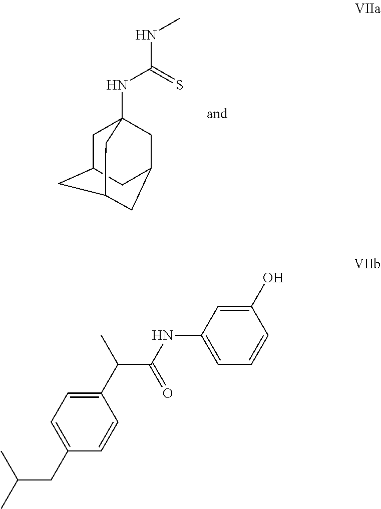 [SMILES: CNC(=S)NC12CC3CC(CC(C3)C1)C2 ; CC(C)Cc1ccc(C(C)C(=O)Nc2cccc(O)c2)cc1]

In an eighth aspect, the present invention provides a pharmaceutical composition for controlling insects. The composition includes a compound selected from the group consisting of:

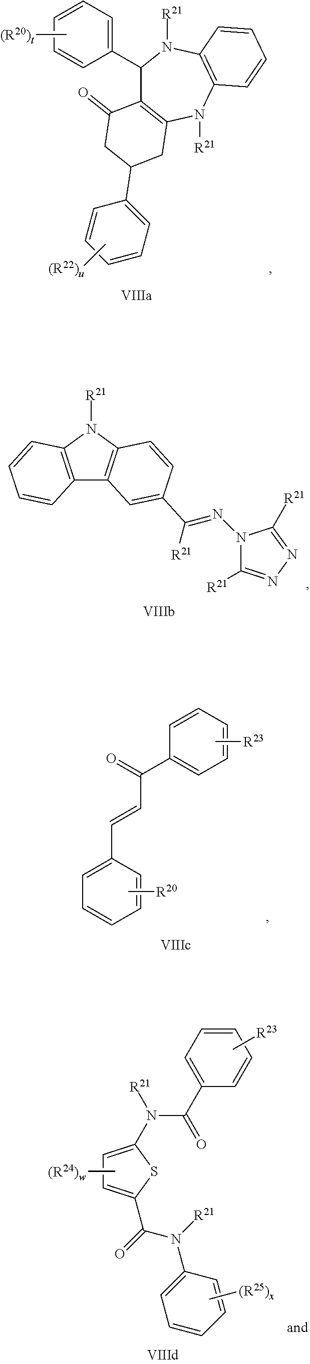

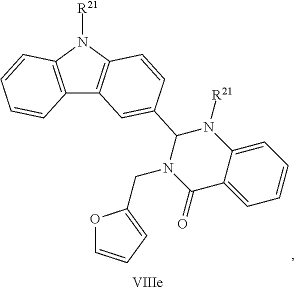

wherein:
each R²⁰ is independently —OH or an alkoxy, such as C₁₋₈alkoxy;
each R²¹ is independently —H or an alkyl, such as C₁₋₈alkyl;
each R²² is independently an alkoxy, such as C₁₋₈alkoxy or any two R²² substituents together with the atoms to which they are attached combined to form a 5-membered ring having from 1-2 heteroatoms selected from N or 0;
R²³ is —H or a halo, such as —Br or —Cl;
each R²⁴ is independently an alkyl or alkyl-OC(O)—; In one embodiment, R²⁴ is C₁₋₈alkyl or C₁₋₈alkyl-OC(O).
each R²⁵ is independently a halo or haloalkyl; for example, R²⁵ is independently —Cl, —Br, or —CF₃.
the subscript t is an integer from 1-3;
the subscript u is an integer from 1-2;
the subscript w is an integer from 1-2; and
   the subscript x is an integer from 1-3.

In one embodiment of the eighth aspect, the pharmaceutical composition includes a compound selected from the group consisting of:

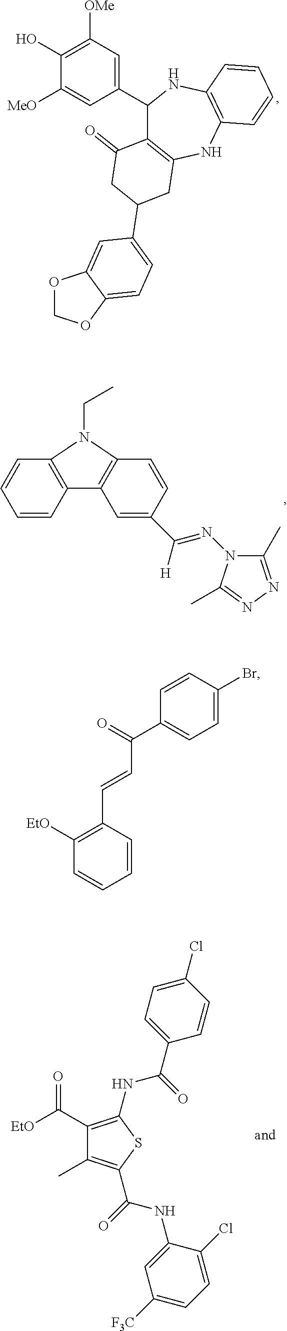 [SMILES: COc1cc(C2Nc3ccccc3NC3=C2C(=O)CC(c2ccc4c(c2)OCO4)C3)cc(OC)c1O ; CCn1c2ccccc2c2cc(/C=N/n3c(C)nnc3C)ccc21 ; CCOc1ccccc1/C=C/C(=O)c1ccc(Br)cc1 ; CCOC(=O)c1c(NC(=O)c2ccc(Cl)cc2)sc(C(=O)Nc2cc(C(F)(F)F)ccc2Cl)c1C]

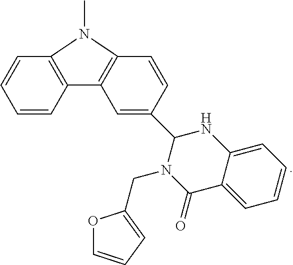 [SMILES: Cn1c2ccccc2c2cc(C3Nc4ccccc4C(=O)N3Cc3ccco3)ccc21]

### Preparation of Compounds

The testing compounds listed in Table 1 were purchased from ChemBridge Corporation (see, web site: http://chembridge.com/chembridge/compound.html). Table 1 listed the corresponding ChemBridge identification number for each of compounds.

| Formula | ChemBridge ID Number |
|---|---|
| Ib | 5,792,670 |
| Ic | 6,240,118 |
| Id | 5,956,517 |
| IIa | 6,240,967 |
| IIIa | 6,23,037 |
| IIIb | 5,990,167 |
| IVa | 6,103,437 |
| IVb | 6,069,394 |
| Va | 6,128,740 |
| Vb | 5930490 |
| VIa | 6,038,111 |
| VIb | 6,130,400 |
| VIc | 6,129,509 |
| VIIa | 5,112,021 |
| VIIb | 5,567,157 |
| VIIIa | 6,073,825 |
| VIIIb | 6,067,962 |
| VIIIc | 6,032,376 |
| VIIId | 6,069,394 |
| VIIIe | 6,157,070 |

Starting materials are either purchased from a commercial supplier, such as Aldrich Chemical Company or are known in the art and prepared in accordance with literature procedures.

Scheme 1 outlines the general synthetic approach to compounds of formulas I and Ia. As shown in Scheme 1, the compounds of formulas I and Ia can be prepared by reacting an amine with a arylsulfonyl chloride using the procedures by Gambill, et al. J. Chem. Educ. 1972, 49, 287. R′ is a non-interfering group. During the synthesis, a person of skill in the art will recognize that certain protecting groups will be used. The protecting groups include hydroxyl or carboxylic acid protecting groups and the like. Examples of protecting groups can be found in T. W. Greene and P. G. Wuts, PROTECTIVE GROUPS IN ORGANIC CHEMISTRY, (Wiley, 2nd ed. 1991), Beaucage and Iyer, Tetrahedron 48:2223-2311 (1992), and Harrison and Harrison et al., COMPENDIUM OF SYNTHETIC ORGANIC METHODS, Vols. 1-8 (John Wiley and Sons. 1971-1996). Representative amino protecting groups include formyl, acetyl, trifluoroacetyl, benzyl, benzyloxycarbonyl (CBZ), tert-butoxycarbonyl (Boc), trimethyl silyl (TMS), 2-trimethylsilyl-ethanesulfonyl (SES), trityl and substituted trityl groups, allyloxycarbonyl, 9-fluorenylmethyloxycarbonyl (FMOC), nitro-veratryloxycarbonyl (NVOC) and the like (see also, Boyle, A. L. (Editor), CURRENT PROTOCOLS IN NUCLEIC ACID CHEMISTRY, John Wiley and Sons, New York, Volume 1, 2000). Representative hydroxy protecting groups include those where the hydroxy group is either acylated or alkylated such as benzyl and trityl ethers as well as alkyl ethers, tetrahydropyranyl ethers, trialkylsilyl ethers and allyl ethers. Additionally, hydroxy groups can be protected by photoremovable groups such as α-methyl-6-nitropiperonyloxycarbonyl (McGall, G. H. and Fidanza, J. A., Photolithographic synthesis of high-density oligonucleotide arrays, in DNA ARRAYS METHODS AND PROTOCOLS, Edited by Rampal J. B., METHODS IN MOLECULAR BIOLOGY, 170:71-101 (2001), Humana Press, Inc., NY; Boyle, Ann L. (Editor), Current Protocols in Nucleic Acid Chemistry, John Wiley and Sons, New York, Volume 1, 2000). The choice of particular reaction conditions is within the abilities of those of ordinary skill in the art.

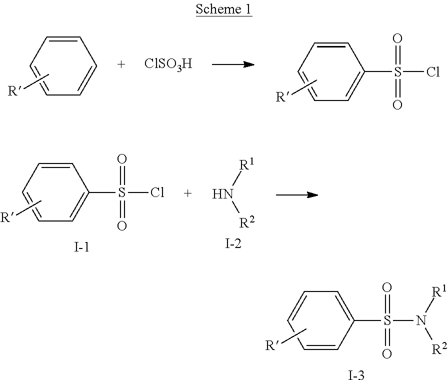

Arylsulfonyl chloride can be prepared according to a reported procedure (see, Gilbert Sulfonation and related reactions; Wiley: New York, 1965, p 84-87). Amine starting materials can be synthesized using conventional chemical transformations known to a person skilled in the art.

Scheme 2 illustrates the synthesis of compounds of formula III. The functional groups in R⁶ can be protected by an hydroxyl, or an amino protecting group found in T. W. Greene and P. G. Wuts, PROTECTIVE GROUPS IN ORGANIC CHEMISTRY, (Wiley, 2nd ed. 1991). Compound 2c can be prepared by nucelophilic addition of 2a to aldehyde 2b in the presence of a base (see, Bunce, et al. J. Chem. Soc. 1963, 303; and Hill, G. et al. Organic Synth. 1941, I, 81). Aldehyde 2b can be obtained from a commercial source or readily synthesized by a person skilled in the art.

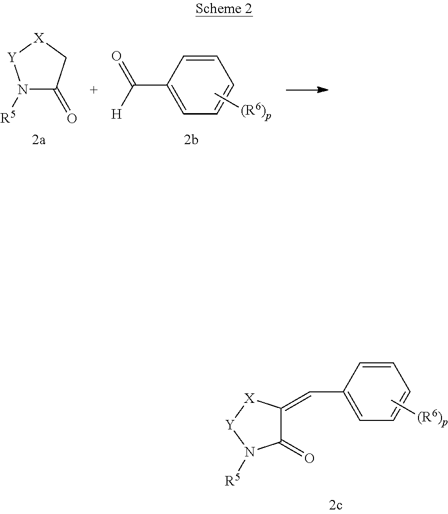

Scheme 3 illustrates the synthesis of compounds of formula IV. The pyrazoline ring is constructed by reaction of carboxohydrazide 3a with a α,β-unsaturated ketone 3b according to literature procedures (see, Helvetica. Chimica Acta 1942, 25, 732; J. Am. Chem. Soc. 1951, 73, 3840; and J. Chem. Soc. 1952, 4686). The starting compounds 3a and 3b can be readily prepared by a person skilled in the art using the conventional chemical transformation reactions.

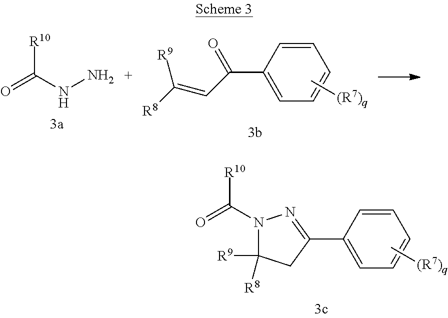

Scheme 4 shows the synthesis of compounds of formula V through a cyclization reaction (see, U.S. Pat. No. 4,218,458), for example, the reaction of a thiourea with a β-amino-α,β-unsaturated ketone.

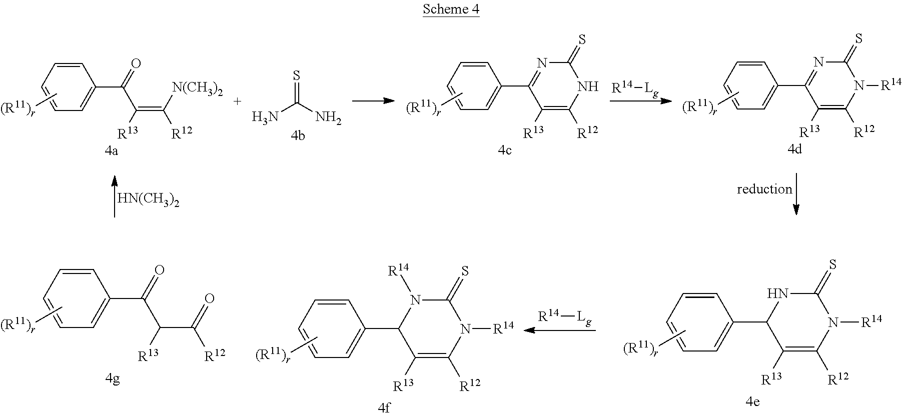

The pyrimidinethione ring can be constructed by an nucleophilic addition and elimination reaction, such as reacting 4a with 4b. Compound 4a can be prepared by reacting β-carbonyl ketone or aldehyde 4g with dialkylamine, such as dimethylamine using a procedure know to a person skilled in the art (see, Org. Syn 1973, 53 48, 59; and Tetrahedron, 1982, 38, 1975, 3363). Primidinethione 4e can be synthesized by selected reduction of the imine bond using sodium cyanoborohydride (see, Lane, C. Synthesis 1975, 135). Substituted pyrimidinethiones 4d and 4f can be prepared by conventional nucleophilic substitution reaction with R¹⁴-L_{g}, where L_{g} is a leaving group, such as a halo or a aryl or alkylsulfonate.

Scheme illustrates the synthesis of compounds of formula VI using the general amide formation reaction by reacting an amine with an carboxylic acid or carboxylic acid derivative. Y is —OH or a leaving group. The reaction condition for forming an amide is well-known to a skilled artisan. The starting materials can either be purchased from a commercial supplier or prepared using the synthetic transformations known in the art.

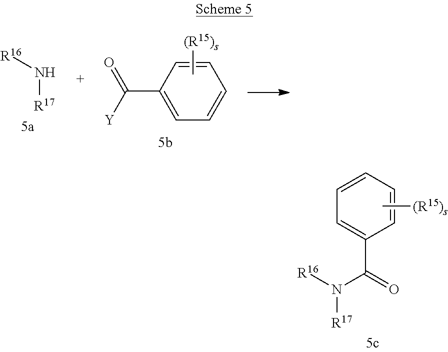

### Compositions

In another aspect, the present invention provides a method of inhibiting RNA silencing mediated viral immunity in an insect. The method includes contacting a pharmaceutical composition with a cell.

The compositions of the present invention comprise RNAi inhibitors in a form suitable for administration to insects. In one embodiment, the compositions are in a water-soluble form, such as being present as pharmaceutically acceptable salts, which is meant to include both acid and base addition salts. “Pharmaceutically acceptable acid addition salt” refers to those salts that retain the biological effectiveness of the free bases and that are not biologically or otherwise undesirable, formed with inorganic acids such as hydrochloric acid, hydrobromic acid, sulfuric acid, nitric acid, phosphoric acid and the like, and organic acids such as acetic acid, propionic acid, glycolic acid, pyruvic acid, oxalic acid, maleic acid, malonic acid, succinic acid, fumaric acid, tartaric acid, citric acid, benzoic acid, cinnamic acid, mandelic acid, methanesulfonic acid, ethanesulfonic acid, p-toluenesulfonic acid, salicylic acid and the like. “Pharmaceutically acceptable base addition salts” include those derived from inorganic bases such as sodium, potassium, lithium, ammonium, calcium, magnesium, iron, zinc, copper, manganese, aluminum salts and the like. Salts derived from pharmaceutically acceptable organic non-toxic bases include salts of primary, secondary, and tertiary amines, substituted amines including naturally occurring substituted amines, cyclic amines and basic ion exchange resins, such as isopropylamine, trimethylamine, diethylamine, triethylamine, tripropylamine, and ethanolamine.

The compositions may also include one or more of the following: carrier proteins such as serum albumin; buffers; fillers such as microcrystalline cellulose, lactose, corn and other starches; binding agents; sweeteners and other flavoring agents; coloring agents; and polyethylene glycol.

The compositions may be prepared by any of the methods well known in the art of pharmacy and drug delivery. All methods include the step of bringing the active ingredient into association with the carrier, which constitutes one or more accessory ingredients. In general, the pharmaceutical compositions are prepared by uniformly and intimately bringing the active ingredient into association with a liquid carrier or a finely divided solid carrier or both, and then, if necessary, shaping the product into the desired formulation. In the pharmaceutical composition, the active object compound is included in an amount sufficient to produce the desired effect upon the process or condition of diseases.

The carriers or excipients may be for example, inert diluents, such as cellulose, silicon dioxide, aluminum oxide, calcium carbonate, sodium carbonate, glucose, mannitol, sorbitol, lactose, calcium phosphate or sodium phosphate; granulating and disintegrating agents, for example, corn starch, or alginic acid; binding agents, for example PVP, cellulose, PEG, starch, gelatin or acacia, and lubricating agents, for example magnesium stearate, stearic acid or talc. Excipients can also include baits, attractants and additives.

Aqueous suspensions contain the active materials in admixture with excipients suitable for the manufacture of aqueous suspensions. Such excipients are suspending agents, for example sodium carboxymethylcellulose, methylcellulose, hydroxy-propylmethylcellulose, sodium alginate, polyvinyl-pyrrolidone, gum tragacanth and gum acacia; dispersing or wetting agents may be a naturally-occurring phosphatide, for example lecithin, or condensation products of an alkylene oxide with fatty acids, for example polyoxyethylene stearate, or condensation products of ethylene oxide with long chain aliphatic alcohols, for example heptadecaethyleneoxycetanol, or condensation products of ethylene oxide with partial esters derived from fatty acids and a hexitol such as polyoxyethylene sorbitol monooleate, or condensation products of ethylene oxide with partial esters derived from fatty acids and hexitol anhydrides, for example polyethylene sorbitan monooleate. The aqueous suspensions may also contain one or more preservatives, for example ethyl, or n-propyl, p-hydroxybenzoate, one or more coloring agents, one or more flavoring agents, and one or more sweetening agents, such as sucrose or saccharin.

Oily suspensions may be formulated by suspending the active ingredient in a vegetable oil, for example arachis oil, olive oil, sesame oil or coconut oil, or in a mineral oil such as liquid paraffin. The oily suspensions may contain a thickening agent, for example beeswax, hard paraffin or cetyl alcohol. Sweetening agents such as those set forth above, and flavoring agents may be added to provide a palatable oral preparation. These compositions may be preserved by the addition of an anti-oxidant such as ascorbic acid.

Dispersible powders and granules suitable for preparation of an aqueous suspension by the addition of water provide the active ingredient in admixture with a dispersing or wetting agent, suspending agent and one or more preservatives. Suitable dispersing or wetting agents and suspending agents are exemplified by those already mentioned above. Additional excipients, for example sweetening, flavoring and coloring agents, may also be present.

The compositions of the invention may also be in the form of oil-in-water emulsions. The emulsions can be prepared with a non-water miscible ingredient such as oils and stabilized with surfactants such as mono-diglycerides, PEG esters and the like. The oily phase may be a vegetable oil, for example olive oil or arachis oil, or a mineral oil, for example liquid paraffin or mixtures of these. Suitable emulsifying agents may be naturally-occurring gums, for example gum acacia or gum tragacanth, naturally-occurring phosphatides, for example soy bean, lecithin, and esters or partial esters derived from fatty acids and hexitol anhydrides, for example sorbitan monooleate, and condensation products of the said partial esters with ethylene oxide, for example polyoxyethylene sorbitan monooleate. The emulsions may also contain sweetening and flavoring agents.

Syrups and elixirs may be formulated with sweetening agents, for example glycerol, propylene glycol, sorbitol or sucrose. Such formulations may also contain a demulcent, a preservative and flavoring and coloring agents. Oral solutions can be prepared in combination with, for example, cyclodextrin, PEG and surfactants.

### V. Formulations

In yet another aspect, the present invention provides a formulation for use in controlling insects or agricultural pests. The formulation includes a composition, which is in the form of a spray, liquid, cream, gel, ointment or towelette and an additive, wherein the formulation is environmentally compatible and exhibiting little or no phytotoxicity. In one embodiment, the additive is a feeding stimulant or bait. In another embodiment, the additive is selected from the group consisting of a filler, water, a surfactant and combinations thereof.

In another aspect, the present invention provides a method of inhibiting RNA silencing mediated viral immunity in an insect. The method includes contacting a composition with a cell.

Many types of insects are controllable by RNAs inhibitors, including flies (e.g., face flies, house flies, stable flies and horn flies), fleas, mosquitoes, flour beetles, cigarette beetles, and cockroaches. Non-limitative examples of suitable insecticides and acaricides are: TABLE-US-00001 1. Abamectin 2. AC 303 630 3. Acephat 4. Acrinathrin 5. Alanycarb 6. Aldicarb 7. .alpha.-Cypermethrin 8. Alphamethrin 9. Amitraz 10. Avermectin B.sub.1 11. AZ 60541 12. Azinphos A 13. Azinphos M 14. Azinphos-methyl 15. Azocyclotin 16. Bacillus subtil, toxin 17. Bendiocarb 18. Benfuracarb 19. Bensultap 20. .beta.-Cyfluthrin 21. Bifenthrin 22. BPMC 23. Brofenprox 24. Bromophos A 25. Bufencarb 26. Buprofezin 27. Butocarboxin 28. Butylpyridaben 29. Cadusafos 30. Carbaryl 31. Carbofuran 32. Carbophenthion 33. Cartap 34. Chloethocarb 35. Chlorethoxyfos 36. Chlorfenapyr 37. Chlorfluazuron 38. Chlormephos 39. Chlorpyrifos 40. Cis-Resmethrin 41. Clocythrin 42. Clofentezin 43. Cyanophos 44. Cycloprothrin 45. Cyfluthrin 46. Cyhexatin 47. D 2341 48. Deltamethrin 49. Demeton M 50. Demeton S 51. Demeton-S-methyl 52. Dibutylaminothio 53. Dichlofenthion 54. Dicliphos 55. Diethion 56. Diflubenzuron 57. Dimethoat 58. Dimethylvinphos 59. Dioxathion 60. DPX-MP062 61. Edifenphos 62. Emamectin 63. Endosulfan 64. Esfenvalerat 65. Ethiofencarb 66. Ethion 67. Ethofenprox 68. Ethoprophos 69. Etrimphos 70. Fenamiphos 71. Fenazaquin 72. Fenbutatinoxid 73. Fenitrothion 74. Fenobucarb 75. Fenothiocarb 76. Fenoxycarb 77. Fenpropathrin 78. Fenpyrad 79. Fenpyroximate 80. Fenthion 81. Fenvalerate 82. Fipronil 83. Fluazinam 84. Fluazuron 85. Flucycloxuron 86. Flucythrinat 87. Flufenoxuron 88. Flufenprox 89. Fonophos 90. Formothion 91. Fosthiazat 92. Fubfenprox 93. HCH 94. Heptenophos 95. Hexaflumuron 96. Hexythiazox 97. Hydroprene 98. Imidacloprid 99. insect-active fungi 100. insect-active nematodes 101. insect-active viruses 102. Iprobenfos 103. Isofenphos 104. Isoprocarb 105. Isoxathion 106. Ivermectin 107. .lamda.-Cyhalothrin 108. Lufenuron 109. Malathion 110. Mecarbam 111. Mesulfenphos 112. Metaldehyd 113. Methamidophos 114. Methiocarb 115. Methomyl 116. Methoprene 117. Metolcarb 118. Mevinphos 119. Milbemectin 120. Moxidectin 121. Naled 122. NC 184 123. NI-25, Acetamiprid 124. Nitenpyram 125. Omethoat 126. Oxamyl 127. Oxydemethon M 128. Oxydeprofos 129. Parathion 130. Parathion-methyl 131. Permethrin 132. Phenthoat 133. Phorat 134. Phosalone 135. Phosmet 136. Phoxim 137. Pirimicarb 138. Pirimiphos A 139. Pirimiphos M 140. Promecarb 141. Propaphos 142. Propoxur 143. Prothiofos 144. Prothoat 145. Pyrachlophos 146. Pyradaphenthion 147. Pyresmethrin 148. Pyrethrum 149. Pyridaben 150. Pyrimidifen 151. Pyriproxyfen 152. RH 5992 153. RH-2485 154. Salithion 155. Sebufos 156. Silafluofen 157. Spinosad 158. Sulfotep 159. Sulprofos 160. Tebufenozide 161. Tebufenpyrad 162. Tebupirimphos 163. Teflubenzuron 164. Tefluthrin 165. Temephos 166. Terbam 167. Terbufos 168. Tetrachlorvinphos 169. Thiafenox 170. Thiodicarb 171. Thiofanox 172. Thionazin 173. Thuringiensin 174. Tralomethrin 175. Triarthen 176. Triazamate 177. Triazophos 178. Triazuron 179. Trichlorfon 180. Triflumuron 181. Trimethacarb 182. Vamidothion 183. XMC (3,5,-Xylyl-methylcarbamate) 184. Xylylcarb 185. YI 5301/5302 186. .zeta.-Cypermethrin 187. Zetamethrin.

Depending on their particular physical and/or chemical properties, the active compound combinations can be converted to the customary formulations, such as solutions, emulsions, suspensions, powders, foams, pastes, granules, aerosols and microencapsulations in polymeric substances and in coating compositions for seeds, and ULV cool and warm fogging formulations.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers. If the extender used is water, it is also possible to employ, for example, organic solvents as auxiliary solvents. Suitable liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide or dimethyl sulfoxide, or else water. Liquefied gaseous extenders or carriers are to be understood as meaning liquids which are gaseous at standard temperature and under atmospheric pressure, for example aerosol propellants such as halogenated hydrocarbons, or else butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as highly disperse silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, corn cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates, or else protein hydrolysates. Suitable dispersants are: for example lignosulfite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other additives can be mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1% and 95% by weight of active compound, preferably between 0.5% and 90% by weight.

The formulation can also include a bait that is adapted to draw the insets or pests to the composition such that it can be readily consumed by insects and pests. A variety of baits are well known and can be used in the formulations of the present invention. Exemplary baits can include an insect/pests food such as agar, potato dextrose agar, sugar beet, gelatin, oil cake, pet food, wheat, wheat flour, soya, oats, corn, rice, fruits, fish by-products, sugars, coated vegetable and cereal seeds, casein, whey, blood meal, bone meal, yeast, paper products, natural and synthetic clays such as diatomaceous earth, talc, magnesium aluminum silicates, kaolinites, calcium carbonate, chalk, fats including suet and lard, a variety of cereals including wheat cereal, and combinations thereof. In an exemplary embodiment, the bait is a wheat cereal, which is commercially available from, for example, Cargill, Inc. of P.O. Box 9300 Minneapolis, Minn. In other embodiments, where the formulation is a dust or a liquid, the formulation can include a dry carrier and/or a solvent, respectively.

The bait can be formed using a technique that first forms a bait pellet from a bait carrier, and then adds a pharmaceutical composition containing RNAs inhibitor as a coating around the pellet. For example, where the bait pellet is formed from a bait carrier can be dispersed in an oil (such as mineral oil, triglyceride oil, and combinations thereof) to form a coating solution. This coating solution can then be applied to the bait carrier pellet, such that it coats the pellet. Alternatively, in other embodiments, either the composition can be incorporated within the carrier core and the other of the composition can be dispersed in an oil and used to coat the resulting pellet. For example, in one embodiment, the method can forming a core from the carrier and at least one composition, and dispersing an amount of a composition in an oil to form a coating to coat a surface of the carrier and composition core. In another embodiment, the method can include forming a core from the carrier and at least one RNAs inhibitor, and dispersing an amount of a composition in an oil to form a coating to coat a surface of the carrier and composition core. One skilled in the art will appreciate the variety of techniques that can be used to form a bait pellet.

Fillers, such as starch, microcrystalline cellulose, sugar, lactose etc. can be used in preparing the composition of the present invention. The filler is chosen so that it will provide a proper environment, for example the filler is used to increase the loading rate of the active ingredient and to adjust the control-release of the active ingredient. In some instances, formulated insecticidal compounds comprise a filler. The amount of filler used may vary, but generally the weight of the filler components will be in the range of about 0.005 to 70% by weight, in one instance about 0.01 to 50% and in another instance, about 0.1 to 15%.

One skilled in the art will appreciate that a variety of other compounds can be added to the RNAs inhibitor formulation depending upon the needs of the user. In one embodiment surfactants, and preferably non-ionic and amphoteric surfactants, can be useful in the formulation. Preferred nonionic surfactants include ethoxylated sorbitan derivatives, ethoxylated fatty acids, and mixtures thereof, such as polysorbate or polyethoxylated castor oil. Exemplary ethoxylated sorbitan derivatives include TWEEN surfactants, such as TWEEN 81 and TWEEN 85, available from ICI Americas, Inc., Agricultural Products Division of Wilmington, Del. Other suitable sorbitan derivatives include EMSORB 6903 and EMSORB 6913, available from Henkel Corp. of Cincinnati, Ohio. Suitable ethoxylated fatty acids include CHEMAX T09 and CHEMAX E400MO available from Chemax, Inc. of Greenville, S.C., and ALKASURF 014 and ALKASURF 09, available from Rhone Poulenc of Cranberry, N.J. Preferred amphoteric surfactants include cetyl (C16) betaine, known chemically as 1-hexadecanaminium,N-(carboxymethyl)N,N-dimethyl-, inner salt (CAS number 693-334) available, from Deforest Enterprises Fla., USA. In another embodiment, the surfactant is an ionic surfactant is derived from a lecithin. In other embodiments, the surfactant is derived from a methyl glucoside coconut oil ester.

In certain embodiments, the percentage of the surfactant in the composition is about 1% to about 20% by weight.

Various hydrophobic agents are suitable for making the composition of the present invention. In certain aspects, the hydrophobic solvent is a fat, vegetable oil, mineral oil, or a combination thereof. The fat or vegetable oil can be, for example, a mono-glyceride, a di-glyceride, a tri-glyceride, or a mixture thereof. In certain aspects, the mineral oil is an aliphatic oil, a paraffinic oil, an isoparaffinic oil, or a mixture thereof.

In certain aspects, the relative amount of the hydrophobic agent to the emulsified composition of this invention is about 0% to about 10% in weight, preferably 1% to about 6% in weight, and more preferably 2% to about 4% in weight.

One skilled in the art will appreciate that the insects or agricultural pests controlling composition can also include additional formulation enhancing additives, such as preservatives or anti-microbial agents, stimulants, ultra violet protectants, antioxidants, waterproofing agents, taste altering additives, or any combination thereof.

A variety of preservatives can be used effectively with the insects or agricultural pests controlling composition of the present invention, and exemplary preservatives include Legend MK® available from Rohm & Haas Company of Philadelphia, Pa., and CA-24 available from Dr. Lehmann and Co. of Memmingen/Allgau, Germany. While the preservatives can be present in the composition in a variety of amounts, preferably the preservatives, such as those listed above for example, can be mixed with water to form a stock solution to be added to the formulation at a concentration in the range of about 1 ppm to 750 ppm.

The insecticidal compositions may also comprise one or more optional components such as attractants, preservatives, anti-oxidants, feeding stimulants, fillers, animal (including human) taste deterrents and colorants.

Stimulants, such as Phagostimulants can be added to the formulation to attract insects and pests and to induce them to feed upon the composition. A variety of phagostimulants can be used, including sugars, yeast products, and casein, and in an exemplary embodiment sugars, such as sucrose, are used. These additives are normally incorporated within the composition in a dry form in a variety of amounts, however typically, they can be added to the composition at about 1 percent by weight to 2.5 percent by weight of the total composition.

Waterproofing agents, which can also act as binders, can also be added to the formulation to improve the composition's weatherability. These are typically water insoluble compounds such as waxy materials and other hydrocarbons. Examples of suitable waterproofing agents are paraffin wax, stearate salts, beeswax, and similar compounds. One preferred wax compound is PAROWAX®, available from Conros Corp. of Scarborough, Ontario, Canada. Waterproofing agents can be incorporated into the formulation in dry form in a variety of amounts, however in an exemplary embodiment waterproofing agents are incorporated into the formulation at about 5 percent by weight to 12 percent by weight of the total formulation.

The formulation can also include taste altering compound to render the composition unpalatable to animals. Exemplary compositions include those having a bitter taste, and suitable compounds that are commercially available include BITREX, available from McFarlane Smith Ltd. of Edinburgh, Scotland. These compounds typically are added at very low concentrations, and, for example, a 0.1% BITREX solution can typically be added to the formulation at about 1 percent by weight to 2 percent by weight of the total formulation.

The insects and pests controlling formulations can be manufactured into e.g., emulsion concentrates, solutions, oil in water emulsions, wettable powders, soluble powders, suspension concentrates, dusts, granules, water dispersible granules, tablets, micro-capsules, gels and other formulation types by well-established procedures. These procedures include intensive mixing and/or milling of the active ingredients with other substances, such as fillers, solvents, solid carriers, surface active compounds (surfactants), and optionally solid and/or liquid auxiliaries and/or adjuvants.

The formulations of the invention can for example, be formulated as wettable powders, water dispersible granules, dusts, granules, solutions, emulsifiable concentrates, emulsions, suspension concentrates and aerosols. Wettable powders usually contain 1.0 to 90% w/w of active ingredient and usually contain in addition to solid inert carrier, 3 to 10% w/w of dispersing and wetting agents and, where necessary, 0 to 10% w/w of stabilizer(s) and/or other additives such as penetrants or stickers. Dusts are usually formulated as a dust concentrate having a similar composition to that of a wettable powder, but without a dispersant, and may be diluted with a solid carrier to give a composition usually containing 0.5 to 10% w/w of active ingredient. Water dispersible granules and granules are usually prepared to have a size between 0.15 mm and 2.0 mm and may be manufactured by a variety of techniques. Generally, these types of granules will contain 0.5 to 90% w/w active ingredient and 0 to 20% w/w of additives such as stabilizer, surfactants, slow release modifiers and binding agents. The so-called “dry flowables” consist of relatively small granules having a relatively high concentration of active ingredient. Emulsifiable concentrates usually contain, in addition to a solvent or a mixture of solvents, 1 to 80% w/v active ingredient, 2 to 20% w/v emulsifiers and 0 to 20% w/v of other additives such as stabilizers, penetrants and corrosion inhibitors. Suspension concentrates are usually milled so as to obtain a stable, non-sedimenting flowable product and usually contain 5 to 75% w/v active ingredient, 0.5 to 15% w/v of dispersing agents, 0.1 to 10% w/v of suspending agents such as protective colloids and thixotropic agents, 0 to 10% w/v of other additives such as defoamers, corrosion inhibitors, stabilizers, penetrants and stickers, and water or an organic liquid in which the active ingredient is substantially insoluble; certain organic solids or inorganic salts may be present dissolved in the formulation to assist in preventing sedimentation and crystallization or as antifreeze agents for water.

Dry insects and pests controlling formulation according to the present invention can be prepared using a variety of techniques. In one embodiment, a suitable amount of the pharmaceutical compositions, can be blended in dry form with dry bait, such as wheat flour. Thereafter, other dry ingredients (such as phagostimulants and waterproofing agents, for example) can be blended and mixed with the composition. Suitable amounts of liquid additives (such as preservatives, taste altering additives and solvents such as water, for example) can also be added to the dry mixture to form a dough. The composition is then preferably covered, such as with plastic wrap, and heated. While a variety of techniques can be used to heat the formulation, in one embodiment, the formulation can be heated in a microwave oven for a time in the range of about 30 seconds to 10 minutes, depending upon the make-up of the formulation. After heating, the dough can be processed in a food grinder to obtain strands of the formulation, which can be dried, at elevated or ambient temperatures, and made into a desired form, such as powder, pellets, cubes, or granules, for example. In other embodiments, composition and a bait carrier can be blended together to form a blended composition. A binding agent, such as wax, can then be added to the composition, and the composition can be passed through a pelletizing mechanism to activate the binding agents. While the pelletizing agent can vary depending upon the type of binding agent used, when the binding agent is wax, the wax can be heated such that it is melted.

In one embodiment, a method of controlling insect pests is provided that includes providing a composition having an effective amount of at least one RNAs inhibitor compound, and at least one bait carrier, and administering an effective amount of the composition to an area infested with insects or pests.

Regardless of the form in which the formulation is presented, e.g., liquid, liquid spray, dust, or solid, the formulation should include an amount of composition that is effective to treat the particular insect or pest. In an exemplary embodiment, the concentration of composition in the Ready-to-Use solid formulation can be in the range of about 1 ppm to 20,000 ppm, more preferably about 1 ppm to 10,000 ppm, even more preferably about 10 ppm to 4,000 ppm, and most preferably about 100 ppm to 1,000 ppm. Moreover, the pH of the applied formulation can be adjusted to be acidic, alkaline, or neutral, depending upon the particular needs of the user. An exemplary pH is in the range of about 6 to 7.

In one embodiment, the RNAs inhibitor composition comprises, based on 100 pbw of the adjuvant composition: (a) greater than or equal to about 0.001 part by weight, more typically from about 0.001 pbw to about to about 0.1 pbw, even more typically from about 0.001 pbw to about 0.05 pbw, and still more typically from about 0.005 pbw to about 0.025 pbw, of one or more betaine surfactant compounds, (b) greater than or equal to about 0.001 part by weight, more typically from about 0.001 pbw to about 0.1 pbw, even more typically from about 0.005 pbw to about 0.095 pbw, and still more typically from about 0.02 pbw to about 0.08 pbw, of one or more surfactant compounds selected from alkyl ether sulfates, sulfonates, sulfosuccinates, alkyl ether carboxylates, alkoxylated fatty acids, and alkoxylated alcohols, and (c) an effective amount of an insect or pest controlling pharmaceutical composition.

In accordance with the invention all plants and plant parts can be treated. Plants are understood here to be all plants and plant populations, such as desirable and undesirable wild plants or cultivated plants (including naturally occurring cultivated plants). Cultivated plants can be plants that can be acquired through conventional breeding and optimization methods or through biotechnological methods and genetic engineering or combinations of these methods, including transgenic plants and including plant species than can and cannot be protected by plant breeder's rights. Plant parts are understood to be all above-ground and underground plant parts and organs, such as the shoot, leaf, flower and root, whereby leaves, needles, stalks, stems, flowers, receptacles, fruits and seeds, as well as roots, tubers and rhizomes are listed as examples. Plant parts also include harvested crops, as well as vegetative and generative propagation material, for example shoots, tubers, rhizomes, runners and seeds.

Hereby the particularly advantageous effect of the compounds of the invention is emphasized in regard to application to cereals, such as wheat, oats, barley, spelt, triticale and rye, as well as corn, millet, rice, sugarcane, soy, sunflowers, potatoes, cotton, rapeseed, canola, tobacco, sugar beets, fodder beets, asparagus, hops, and fruit plants (including pomeaceous fruits such as apples and pears; stone fruits such as peaches, nectarines, cherries, plums and apricots; citrus fruits such as oranges, grapefruits, limes, lemons, kumquats, mandarins and satsumas; nuts such as pistachios, almonds, walnuts and pecans; tropical fruits such as mango, papaya, pineapple, dates and bananas; and grapes) and vegetables [including leafy green vegetables such as endives, corn salad, Florence fennel, head and loose-leaf lettuce, common beets, spinach and Belgian endive; cole crops such as cauliflower, broccoli, Chinese cabbage, kale (green or curly kale), kohlrabi, Brussels sprouts, red cabbage, white cabbage and savoy cabbage; fruiting vegetables such as eggplants, cucumbers, peppers, edible pumpkins and squashes, tomatoes, zucchini and sweet corn; root vegetables such as celeriac, turnips, carrots, baby carrots, radishes, baby radishes, garden beets, black salsify, celery; legumes such as peas and beans; and alliums such as leeks and onions].

The treatment of plants and plant parts with the active ingredient combinations in accordance with the invention occurs directly, or through action on the environment, habitat or storage area in accordance with customary treatment methods, e.g., dipping, spraying, vaporizing, nebulising, sprinkling, coating, and for propagation material, in particular seeds, by one-layer or multi-layer encasing of the seeds.

The present invention also provides using a spray that employs at least one spraying, dispensing, diffusing or mistyfying process. For example, the process includes using a spray selected from the group consisting of a fragrance and lotion pump, fine mist sprayer, a specialty pump, an anti-clog pump, a spray-through cap, a nozzle, an airless pump, an airless dispenser, a dual dispensing pump, a fine mist pump, a trigger pump, a foam pump, a trigger sprayer, an aerosol sprayer, a squeeze roamer and combinations thereof to provide an application of said spray.

One skilled in the art will appreciate that the RNAs inhibitor compositions disclosed herein are not only effective in controlling insects and pests, but also environmentally sound and safe for human use, highly active, less resistance and a universal approach to counter antiviral immunity defense. Further, some of the compositions can be residual in that they do not leach out of baits during rain, and thus can protect against insect and pests during and after rainy weather.

### VI. Methods for Identifying Compounds of RNA Silencing Suppressors

In certain embodiments, the invention comprises methods for identifying compounds as inhibitors for RNA silencing and modulators of the antiviral RNA silencing pathway. Typically, the methods of this invention are used to identify inhibitors of RNA silencing suppressors and enhancers of the antiviral RNA silencing pathway.

The term “test compound” or “candidate compound” or “modulator” or grammatical equivalents as used herein describe any molecule, e.g., protein, oligopeptide, small organic molecule, polysaccharide, polynucleotide, etc., to be tested for the capacity to directly or indirectly alter the activity of RNA silencing suppressors and/or genes in the antiviral RNA silencing pathway.

In some embodiments, an insect cell or insect is infected with virus and the insect cell is contacted with a candidate modulator or the insect is exposed to the modulator. By “exposing” or “contacting” herein is meant that the candidate agent is administered in such a manner as to allow the agent to act upon the insect. Generally, a plurality of different modulator concentrations are tested to obtain a differential response to the various concentrations. Typically, one of these concentrations serves as a negative control, i.e., at zero concentration or below the level of detection.

A. Compounds to be Screened

The compounds tested as modulators of the activity of RNA silencing suppressors and the antiviral RNA silencing pathway can be any small chemical compound, or a biological entity, such as a protein, sugar, nucleic acid or lipid. Typically, test compounds will be small chemical molecules and peptides. Essentially any chemical compound can be used as a potential modulator or ligand in the assays of the invention, although most often compounds can be dissolved in aqueous or organic (especially DMSO-based) solutions are used. It will be appreciated that there are many suppliers of chemical compounds, including ChemBridge (SanDiego, Calif.), Sigma (St. Louis, Mo.), Aldrich (St. Louis, Mo.), Sigma-Aldrich (St. Louis, Mo.), Fluka Chemika-Biochemica Analytika (Buchs Switzerland and the like.

### Combinatorial Chemistry Libraries

In certain embodiments, combinatorial libraries of potential modulators will be screened for an ability to bind to modulate RNA silencing suppressors and components of the antiviral RNA silencing defense pathway. Conventionally, new chemical entities with useful properties are generated by identifying a chemical compound (called a “lead compound”) with some desirable property or activity, e.g., inhibiting activity, creating variants of the lead compound, and evaluating the property and activity of those variant compounds.

In one embodiment, the drug screening method involves providing a combinatorial chemical or peptide library containing a large number of potential therapeutic compounds (potential modulator or ligand compounds). Such “combinatorial chemical libraries” or “ligand libraries” are then screened in one or more assays, as described herein, to identify those library members (particular chemical species or subclasses) that display a desired characteristic activity. The compounds thus identified can serve as conventional “lead compounds” or can themselves be used as potential or actual therapeutics.

A combinatorial chemical library is a collection of diverse chemical compounds generated by either chemical synthesis or biological synthesis, by combining a number of chemical “building blocks” such as reagents. For example, a linear combinatorial chemical library such as a polypeptide library is formed by combining a set of chemical building blocks (amino acids) in every possible way for a given compound length (i.e., the number of amino acids in a polypeptide compound). Millions of chemical compounds can be synthesized through such combinatorial mixing of chemical building blocks.

Preparation and screening of combinatorial chemical libraries is well known to those of skill in the art. Such combinatorial chemical libraries include, but are not limited to, peptide libraries (see, e.g., U.S. Pat. No. 5,010,175, Furka, Int. J. Pept. Prot. Res. 37:487-493 (1991) and Houghton et al., Nature, 354:84-88 (1991)). Other chemistries for generating chemical diversity libraries can also be used. Such chemistries include, but are not limited to: peptoids (e.g., PCT Publication No. WO 91/19735), encoded peptides (e.g., PCT Publication No. WO 93/20242), random bio-oligomers (e.g., PCT Publication No. WO 92/00091), benzodiazepines (e.g., U.S. Pat. No. 5,288,514), diversomers such as hydantoins, benzodiazepines and dipeptides (Hobbs et al., Proc. Nat. Acad. Sci. USA, 90:6909-6913 (1993)), vinylogous polypeptides (Hagihara et al., J. Amer. Chem. Soc., 114:6568 (1992)), nonpeptidal peptidomimetics with glucose scaffolding (Hirschmann et al., J. Amer. Chem. Soc., 114:9217-9218 (1992)), analogous organic syntheses of small compound libraries (Chen et al., J. Amer. Chem. Soc., 116:2661 (1994)), oligocarbamates (Cho et al., Science, 261:1303 (1993)), and/or peptidyl phosphonates (Campbell et al., J. Org. Chem., 59:658 (1994)), nucleic acid libraries (see Ausubel, Berger and Sambrook, all supra), peptide nucleic acid libraries (see, e.g., U.S. Pat. No. 5,539,083), antibody libraries (see, e.g., Vaughn et al., Nature Biotechnology, 14(3):309-314 (1996) and PCT/US96/10287), carbohydrate libraries (see, e.g., Liang et al., Science, 274:1520-1522 (1996) and U.S. Pat. No. 5,593,853), small organic molecule libraries (see, e.g., benzodiazepines, Baum C&EN, January 18, page 33 (1993); isoprenoids, U.S. Pat. No. 5,569,588; thiazolidinones and metathiazanones, U.S. Pat. No. 5,549,974; pyrrolidines, U.S. Pat. Nos. 5,525,735 and 5,519,134; morpholino compounds, U.S. Pat. No. 5,506,337; benzodiazepines, U.S. Pat. No. 5,288,514, and the like).

A number of well known robotic systems have also been developed for solution phase chemistries. These systems include automated workstations like the automated synthesis apparatus developed by Takeda Chemical Industries, LTD. (Osaka, Japan) and many robotic systems utilizing robotic arms (Zymate II, Zymark Corporation, Hopkinton, Mass.; Orca, Hewlett-Packard, Palo Alto, Calif.), which mimic the manual synthetic operations performed by a chemist. The above devices, with appropriate modification, are suitable for use with the present invention. In addition, numerous combinatorial libraries are themselves commercially available (see, e.g., ComGenex, Princeton, N.J., Asinex, Moscow, Ru, Tripos, Inc., St. Louis, Mo., ChemStar, Ltd, Moscow, RU, 3D Pharmaceuticals, Exton, Pa., Martek Biosciences, Columbia, Md., etc.).

### Proteins and Nucleic Acids as Potential Modulators

In one embodiment, the modulators are proteins, often naturally occurring proteins or fragments of naturally occurring proteins. Thus, e.g., cellular extracts containing proteins, or random or directed digests of proteinaceous cellular extracts, may be used. In this way libraries of proteins may be made for screening in the methods of the invention. These can include, but are not limited to, libraries of bacterial, fungal, viral, and mammalian proteins. Typically, the libraries comprise human proteins.

In one embodiment, modulators are peptides of from about 5 to about 30 amino acids, from about 5 to about 20 amino acids, or from about 7 to about 15. The peptides may be digests of naturally occurring proteins as is outlined above, random peptides, or “biased” random peptides. By “randomized” or grammatical equivalents herein is meant that the nucleic acid or peptide consists of essentially random sequences of nucleotides and amino acids, respectively. Since these random peptides (or nucleic acids, discussed below) are often chemically synthesized, they may incorporate any nucleotide or amino acid at any position. The synthetic process can be designed to generate randomized proteins or nucleic acids, to allow the formation of all or most of the possible combinations over the length of the sequence, thus forming a library of randomized candidate bioactive proteinaceous agents.

In one embodiment, the library is fully randomized, with no sequence preferences or constants at any position. Typically, the library is biased. That is, some positions within the sequence are either held constant, or are selected from a limited number of possibilities. In another embodiment, the nucleotides or amino acid residues are randomized within a defined class, e.g., of hydrophobic amino acids, hydrophilic residues, sterically biased (either small or large) residues, towards the creation of nucleic acid binding domains, the creation of cysteines, for cross-linking, prolines for SH-3 domains, serines, threonines, tyrosines or histidines for phosphorylation sites, etc.

Modulators can also be nucleic acids, as defined above. As described above generally for proteins, nucleic acid modulating agents may be naturally occurring nucleic acids, random nucleic acids, or “biased” random nucleic acids. Digests of prokaryotic or eukaryotic genomes may be used as is outlined above for proteins.

B. The Screening Process

Candidate modulators can be identified by infecting insect cells with any native virus which activates RNA silencing. The effect of such modulators can then be determined by measuring accumulation of viral RNA. RNA levels can be determined using any standard method known to those of skill in the art, such as visual assays indicating transcription of reporter molecules or Northern blots. In other embodiments, RNA levels can be measured using labeled probes or amplification-based assays.

Probes to detect RNA can be a nucleotide/deoxynucleotide probe that is complementary to and hybridizes with the RNA and includes, but is not limited to, oligonucleotides, cDNA or RNA. Probes also should contain a detectable label as defined in the art. In one method the RNA is detected after immobilizing the RNA to be examined on a solid support such as nylon membranes and hybridizing the probe with the sample. Following washing to remove the non-specifically bound probe, the label is detected. In another method detection of the RNA is performed in situ. In this method permeabilized cells or tissue samples are contacted with a detectably labeled nucleic acid probe for sufficient time to allow the probe to hybridize with the target RNA. Following washing to remove the non-specifically bound probe, the label is detected. For example a digoxygenin labeled riboprobe (RNA probe) that is complementary to the RNA is detected by binding the digoxygenin with an anti-digoxygenin secondary antibody and developed with nitro blue tetrazolium and 5-bromo-4-chloro-3-indoyl phosphate.

Often, amplification-based assays are performed to measure the expression level of viral RNAs. These assays are typically performed in conjunction with reverse transcription. In such assays, a nucleic acid sequence acts as a template in an amplification reaction (e.g., Polymerase Chain Reaction, or PCR). In a quantitative amplification, the amount of amplification product will be proportional to the amount of template in the original sample. Comparison to appropriate controls provides a measure of the amount of RNA. Methods of quantitative amplification are well known to those of skill in the art. Detailed protocols for quantitative PCR are provided, e.g., in Innis et al., PCR Protocols, A Guide to Methods and Applications (1990).

In some embodiments, a TaqMan based assay is used to measure expression. TaqMan based assays use a fluorogenic oligonucleotide probe that contains a 5′ fluorescent dye and a 3′ quenching agent. The probe hybridizes to a PCR product, but cannot itself be extended due to a blocking agent at the 3′ end. When the PCR product is amplified in subsequent cycles, the 5′ nuclease activity of the polymerase, e.g., AmpliTaq, results in the cleavage of the TaqMan probe. This cleavage separates the 5′ fluorescent dye and the 3′ quenching agent, thereby resulting in an increase in fluorescence as a function of amplification (see, e.g., literature provided by Perkin-Elmer, e.g., www2.perkin-elmer.com).

Other suitable amplification methods include, but are not limited to, ligase chain reaction (LCR) (see Wu & Wallace, Genomics, 4:560 (1989), Landegren et al., Science, 241:1077 (1988), and Barringer et al., Gene, 89:117 (1990)), transcription amplification (Kwoh et al., Proc. Natl. Acad. Sci. USA, 86:1173 (1989)), self-sustained sequence replication (Guatelli et al., Proc. Nat. Acad. Sci. USA, 87:1874 (1990)), dot PCR, and linker adapter PCR, etc.

### VII. EXAMPLES

### Example 1

### Screening Protocol

A cell-based high throughput screening protocol for the identification of chemical inhibitors of the RNAi-mediated innate immunity against virus infection in cultured Drosophila cells has been established. The system is based on Flock house virus (FHV), an animal Nodavirus that contains a bipartite RNA genome. FHV RNA2 encodes the single virion structural protein, whereas FHV RNA1 encodes the viral RNA-dependent RNA polymerase (RdRP) and B2, a viral suppressor of RNAi (VSR) expressed after RNA1 replication from its own mRNA, RNA3. In the absence of RNA2, RNA1 replicates autonomously, accumulates to high levels, and produces abundant RNA3 in Drosophila cells. However, a mutant of RNA1 that does not express B2, called R1ΔB2, accumulates to detectable levels only in Drosophila cells that are defective for RNAi, but not in wild type cells due to degradation of viral RNAs by antiviral RNAi. Similarly, green fluorescence is not detectable in wild type Drosophila cells transfected with pR1gfp, which encodes a recombinant RNA1 in which the viral B2 gene is replaced with green fluorescent protein (GFP) gene. A stable Drosophila Schneider 2 cell line has been established, and carries pR1gfp, called line R1gfp. R1gfp cells were seeded in 96-well plates and incubated overnight with chemicals from ChemBridge Diverset Library before FHV replication was induced. Expression of GFP was screened in R1gfp cells two days following the induction of FHV replication (see, Li et al., Proc Natl Acad Sci USA 2004, 101(5), 1350-5).

### Example 2

### Inhibition of RNAi Mediated Viral Immunity

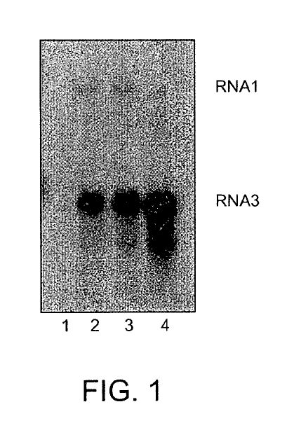

Compounds 3-(2-methyl-1H-benzimidazol-1-yl0-1-(3-methlphenyl)-2,5-pyrrolidinedione (Rin1), 1-[3-(benzyloxy)-4-methoxybenzyl]-4-[(4-methylphenyl)sulfony]piperazine (Rin2), and 1-(3-chloro-4-methylphenyl)-4-[4-(diethylamino)-2-hydroxybenzylidene]-3,5-pyrazolidinedione (Rin3) were found to inhibit the RNAi-mediated viral immunity, leading to detection of green fluorescence in R1gfp cells after induction of FHV replication (data not shown). Northern blot hybridization confirmed accumulation of viral RNAs 1 and 3 in cells pre-treated with the chemicals (see, FIG. 1, lanes 2-4), but not in cells pre-treated with DMSO alone (see, FIG. 1, lane 1).

### Example 3

### Inhibition of RNAi Induced by Synthetic Double-Stranded RNA (dsRNA)

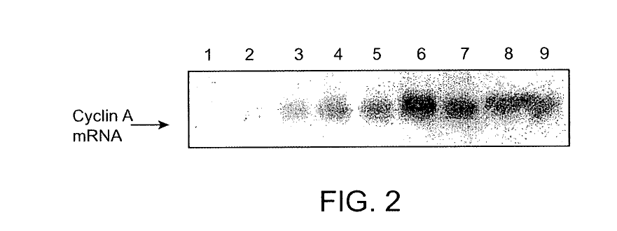

Compounds Rin1, Rin2 and Rin3 were also active inhibitors of RNAi induced by synthetic double-stranded RNA (dsRNA). Degradation of cyclin A mRNA occurred in S2 cells transfected with a dsRNA specific to cyclin A (dsCycA) (see, FIG. 2, lanes 1-2), but not in cells treated with a GFP-specific dsRNA (dsGFP) (see, FIG. 2, lane 8). We found that degradation of cyclin A mRNA targeted by dsCycA was partially inhibited by treatment with either of the three compounds (see, FIG. 2, lanes 3-5). Similar inhibition of cyclin A RNAi was also observed in cells co-transfected with a dsRNA targeting mRNA of Drosophila Ago2 (see, FIG. 2, lane 9), which is essential for RNAi in Drosophila.

### Example 4

### Inhibition the Activity of siRNAs

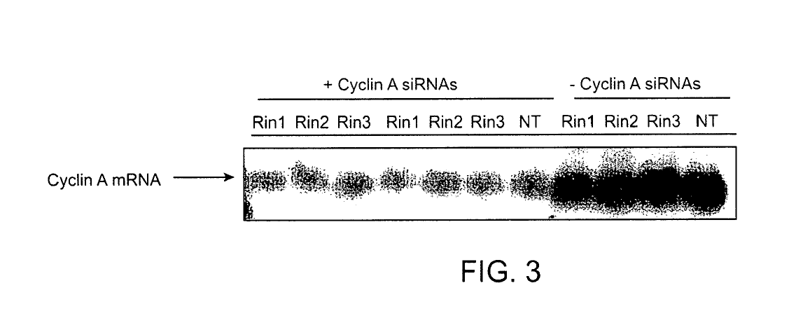

S2 cells were transfected with two siRNAs specific to cyclin A in the presence and the absence of the Rin compounds at both 30 μM (see, FIG. 3, lanes 1-3) and 10004 (see, FIG. 3, lanes 4-6). At both concentrations the chemicals were not able to block the activity of the siRNAs as the levels of cyclin A mRNA showed no significant difference as compared to untreated cells (see, FIG. 3, lane 7). The Rin compounds did not have any effect on cyclin A mRNA levels in cells that were not exposed to siRNAs (see, FIG. 3, lanes 8-11). Thus, our data collectively suggests that these chemicals perturb the production of siRNAs from the long dsRNA precursor.

### Example 5

### Effect of RNAi Inhibitors on the miRNA Pathway in Drosophila Cells

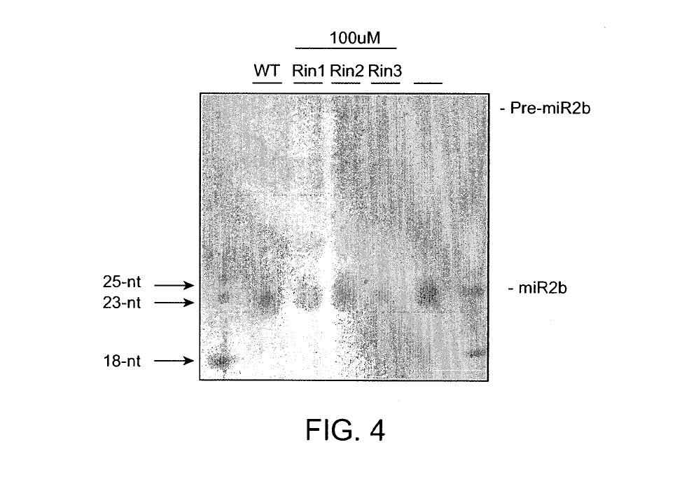

Both the mature microRNA2b (miR2b) and its precursor, pre-miR2b, accumulated to approximately 2-fold lower levels in S2 cells treated with increased Rin concentrations (100 μM) than in untreated wild-type cells (see, FIG. 4, compare lanes 2-4 with lanes 1 & 5). In Drosophila, primary miRNAs are processed by the dsRNA-specific RNase Drosha into pre-miRNAs, which in turn are processed into mature miRNAs by Dcr-1. Thus, our results indicate that Rin treatment interfered with the production of pre-miRNA and/or miRNA, which further supports the idea that these chemicals perturb the biogenesis of small RNAs.

### Example 6

### Other Applications of RNAi Inhibitors

A recent paper reported identification of two chemicals from a small library of synthetic ATP analogs that can inhibit the unwinding of siRNAs in human cells (Chiu et al., Chemistry and Biology 2005, 12(6), 643-8). Thus, screening of additional compounds in ChemBridge and other libraries may identify RNAi inhibitor compounds that act downstream of siRNA biogenesis similar to the ATP analogs.

RNAi pathway can protect adult fruit flies from infection by evolutionarily diverse viruses. Notably, fly mutants compromised for RNAi also exhibited near 100% mortality rate 10 days after infection with Flock house virus, which is of low virulence to wild type flies (Wang et al., Science 2006, 312(5772), 452-4). Not being bound by theory, it is likely that application of RNAi inhibitors and functionally and/or chemically related compounds will disrupt the RNAi-mediated viral immunity of insects such as mosquitoes and agricultural pets and significantly enhance the virulence of viruses endemic in the wild populations. Similarly, more than half of human genes are likely under miRNA control and miRNAs act as oncogenes in human cancers (Hammond, Cancer Chemother Pharmacol 58 Suppl 7, 63-8). Not being bound by theory, it is likely that the Rin class of molecules has potential to treat human diseases in which miRNAs play a direct or indirect role.

1-84. (canceled)

85. A method for inhibiting RNA silencing mediated viral immunity in an insect, said method comprising: contacting the insect with an effective amount of a compound of formula (I): 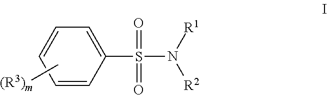
and a pharmaceutically acceptable carrier or excipient,
wherein R¹ is selected from the group consisting of —H and alkyl; R² is heterocycloalkyl-C₁₋₄alkylene; or R¹ and R² together with the nitrogen atom to which they are attached to form a 5- or 6-membered hetercyclic ring containing 1-3 heteroatoms selected from O or N, wherein the heterocycloalkyl is optionally substituted with from 1-2 members selected from the group consisting of alkyl and aryl-C₁₋₄alkyl, wherein the aryl group is substituted with from 1-2 members selected from the group consisting of alkyl, alkoxy and arylalkyloxy;
each R³ is independently selected from the group consisting of alkyl, alkoxy, —C(O)OH and —C(O)Oalkyl, or any two R³ together with the atoms to which they are attached are combined to form a 6-membered carbocyclic aromatic ring, optionally substituted with alkoxy; and
m is an integer from 1-5.

86. The method of claim 85, wherein the compound has formula Ia:

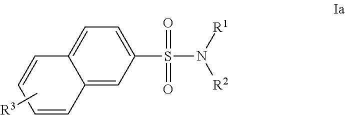

87. The method of claim 85, wherein R¹ is —H or C₁₋₈ alkyl.

88. The method of claim 85, wherein R¹ is —H.

89. The method of claim 85, wherein R² is C₄-heterocycloalkyl-C₁₋₄ alkylene or furyl-2-methyl.

90. The method of claim 85, wherein R² is furyl-2-methyl.

91. The method of claim 85, wherein —NR¹R² is selected from the group consisting of piperidinyl and piperazinyl, each of which is optionally substituted with alkyl or aryl.

92. The method of claim 85, wherein —NR¹R² is 1-piperidinyl substituted with an alkyl.

93. The method of claim 85, wherein —NR¹R² is 1-piperazinyl substituted with an arylalkyl, wherein the aryl group is further substituted with 1-2 members selected from C₁₋₈alkoxy and aryl-C₁₋₄alkyloxy.

94. The method of claim 85, wherein R³ is selected from the group consisting of C₁₋₈alkoxy, —C(O)OH and —C(O)OC₁₋₈alkyl.

95. The method of claim 85, wherein the compound has a formula selected from the group consisting of:

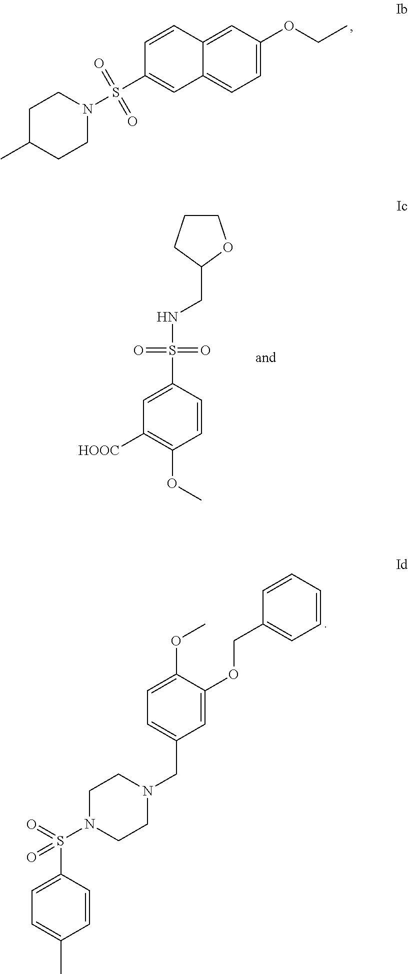 [SMILES: CCOc1ccc2cc(S(=O)(=O)N3CCC(C)CC3)ccc2c1 ; COc1ccc(S(=O)(=O)NCC2CCCO2)cc1C(=O)O ; COc1ccc(CN2CCN(S(=O)(=O)c3ccc(C)cc3)CC2)cc1OCc1ccccc1]

96. The method of claim 85, wherein the insects are mosquitoes and agricultural pests.

97. The method of claim 85, wherein the composition is formulated as a spray, liquid, cream, gel, ointment or towelette.

98. The method of claim 85, wherein the carrier or excipient comprises an additive selected from a feeding stimulant or bait.

99. The method of claim 85, wherein the carrier or excipient comprises an additive selected from the group consisting of a filler, water, a surfactant and combinations thereof.
